(19) United States
(12) Patent Application Publication
(10) Pub. No.: US 2023/0017074 A1
(43) Pub. Date: Jan. 19, 2023

(54) POWER OPERATED ROTARY KNIFE WITH MODIFIED HANDLE ASSEMBLY AND FRAME BODY

(71) Applicant: Bettcher Industries, Inc., Birmingham, OH (US)

(72) Inventor: MATTHEW D. GALL, Strongsville, OH (US)

(21) Appl. No.: 17/864,108

(22) Filed: Jul. 13, 2022

Related U.S. Application Data
(60) Provisional application No. 63/221,421, filed on Jul. 13, 2021.

(51) Int. Cl. B26D 1/157

(52) U.S. Cl. CPC B26D 1/157

(57) ABSTRACT

A power operated trimming tool, such as a hand-held, power operated rotary knife, configured for coupling to an end-of-arm tool connector of a robotic arm. The power operated trimming tool includes: a head assembly and a handle assembly extending the frame body along a handle assembly longitudinal axis. The head assembly including a frame body configured for coupling to the robotic arm tool connector. The handle assembly including: a central core including a threaded exterior section and a distal interface portion engaging a proximal interface portion of the frame body to attach the handle assembly to the frame body; a connector engagement member including a distal portion contacting the tool connector and a proximal portion including a threaded interior section engaging the central core threaded exterior section, and a driver assembly retainer member including a distal portion including a threaded interior section engaging the central core threaded exterior section.

### CROSS REFERENCE TO RELATED APPLICATIONS

The following application claims priority under 35 U.S.C. § 119(e) to co-pending U.S. Provisional Patent Application Ser. No. 63/221,421, filed Jul. 13, 2021, entitled Power Operated Rotary Knife With Modified Handle Assembly And Frame Body. The above-identified U.S. provisional patent application is incorporated by reference herein in its entirety for any and all purposes.

### TECHNICAL FIELD

The present disclosure relates to a power operated trimming tool, such as a power operated rotary knife, and, more specifically, to a power operated rotary knife having a modified handle assembly and frame body adapted to be coupled to an end-of-arm tool connector of a robotic arm providing for manipulation of the power operated trimming tool by the robotic arm.

### BACKGROUND

Hand-held, power operated trimming tools, such as hand-held, power operated rotary knives and hand-held, power operated skinning devices, are widely used in meat and fish processing facilities for cutting and trimming operations on various meat and fish products and carcasses. Additionally, hand-held, power operated rotary knives also have application in a variety of other industries where cutting and/or trimming operations need to be performed quickly and with less effort than would be the case if traditional manual cutting or trimming tools were used, e.g., long knives, scissors, nippers, etc. By way of example, hand-held, power operated rotary knives may be effectively utilized for such diverse tasks as tissue harvesting or recovery, debriding/removal of skin tissue, bone tissue, tendon/ligament harvesting from human or animal tissue donors for medical purposes. Hand-held, power operated rotary knives may also be used for taxidermy and for cutting and trimming of elastomeric or urethane foam for a variety of applications including vehicle seats.

Hand-held, power operated rotary knives typically include a handle assembly and a head assembly attached to the handle assembly. The head assembly includes a frame body supporting an annular blade housing. In turn, an annular rotary knife blade is supported for rotation by the blade housing. The annular rotary blade of conventional power operated rotary knives is typically rotated by a drive assembly which include a flexible shaft drive assembly extending through an opening in the handle assembly. The shaft drive assembly engages and rotates a pinion gear of the drive assembly. The pinion gear is supported by the head assembly. The flexible shaft drive assembly includes a stationary outer sheath and a rotatable interior drive shaft which is driven by an electric motor. Alternatively, the pinion gear may be driven by a pneumatic motor mounted within the handle assembly. Gear teeth of the pinion gear engage mating gear teeth formed on an upper surface of the rotary knife blade.

Upon rotation of the pinion gear by the drive shaft of the flexible shaft drive assembly, the annular rotary blade rotates within the blade housing at a high RPM, on the order of 900-1900 RPM, depending on the structure and characteristics of the drive assembly including the motor, the shaft drive assembly, and a diameter and the number of gear teeth formed on the rotary knife blade. Power operated rotary knives are disclosed in U.S. Pat. No. 9,522,473 to Mascari et al., U.S. Pat. No. 10,040,211 to Whited, U.S. Pat. No. 10,124,500 to Whited et al., and U.S. Pat. No. 10,471,614 to Whited et al., all of which are assigned to the assignee of the present application and all of which are incorporated by reference herein, in their respective entireties.

Hand-held, power operated skinning devices are typically used for removing a layer of skin from an animal carcass. A hand-held, power operated skinning device or skinner also typically includes a handle assembly and a head assembly attached to the handle assembly. The head assembly includes a frame body and a feed roll supported for rotation by a feed roll shaft which, in turn, is supported by the frame body. The feed roll includes a worm wheel that is rotatably driven by a drive assembly. The drive assembly includes a drive shaft having a worm gear driver that engages the worm wheel of the feed gear to rotate the feed roll about a feed roll axis of rotation defined by the feed roll shaft. The drive assembly of the power operated skinner may additionally include a flexible shaft drive assembly extending through an opening in the handle assembly. The shaft drive assembly engages and rotates the drive shaft and worm gear driver. Power operated skinning devices are disclosed in U.S. Pat. No. 10,731,713 to Gall et al. and U.S. Pat. Np. 11,026,434 to Sukey, all which are assigned to the assignee of the present application and all of which are incorporated by reference herein, in their respective entireties.

The handle assembly of hand-held, power operated rotary trimming tools, such as hand-held, power operated rotary knives, typically include an overlying hand piece that defines a gripping surface for the operator of the power operated rotary knife. The hand piece of a power operated rotary knife (or power operated skinning device) is gripped by the hand of the operator and the knife is appropriately manipulated by the operator such that a cutting region of the knife moves with respect to a workpiece to make appropriate cutting and trimming operations on the workpiece. Hence, power operated rotary knives have typically been referred to as hand-held, power operated rotary knives and the handle assembly was ergonomically designed for ease of gripping and manipulation by a human operator's hand.

Recently, robotics and, specifically, the use of robotic arms have become more prevalent in various fields of use, including meat and fish cutting and trimming operations. Accordingly, for certain cutting and trimming applications, it is desired that hand-held, power operated trimming tools, such as a hand-held, power operated rotary knife or a hand-held, power operated skinning device, be modified so as to be suitable for manipulation by an end-of-arm tool connector coupled to and extending from a robotic arm, as opposed to being manipulated by a human operator grasping the tool in his or her hand. That is, the power operated rotary knife will be coupled to the end-of-arm tool connector of the robotic arm and function, under the control of the robotic arm, as an end effector or end-of-arm tooling (EOAT) for the robotic arm. Thus, it is desired that one or more components of a handle assembly and/or a head assembly of a power operated trimming tool, such as a power operated rotary knife, be modified or configured for attachment to an end-of-arm tool connector of a robotic arm thereby allowing the robotic arm to appropriately manipulate the power operated rotary knife for desired meat and fish cutting and trimming operations. Further, it is desired that one or more components of a handle assembly and/or a head assembly of a power operated trimming tool, such as a power operated rotary knife, be configured such that the power operated rotary knife may be readily converted from a configuration suitable for manual manipulation of the power operated rotary knife by a human operator to a configuration suitable for attachment to an end-of-arm tool connector of a robotic arm for robotic manipulation of the power operated rotary knife.

### SUMMARY

In one aspect, the present disclosure relates to a handle assembly for a power operated trimming tool configured to be coupled to an interface portion of an end-of-arm tool connector of a robotic arm, the power operated trimming tool including a head assembly supporting a drive mechanism of the power operated trimming tool and the handle assembly extending from a proximal interface portion of a frame body of the head assembly, the handle assembly including a through bore extending along a handle assembly longitudinal axis, the through bore configured for receiving a driver assembly of a shaft drive transmission, the driver assembly operatively coupled to the drive mechanism of the power operated trimming tool, the handle assembly comprising: a) a central core extending along the handle assembly longitudinal axis and including a central through bore defining a portion of the handle assembly through bore, the central core including a first distal interface portion and a threaded exterior section, the first distal interface portion configured to engage a proximal interface portion of a frame body to attach the handle assembly to a frame body; b) a connector engagement member having a central opening extending along the handle assembly longitudinal axis and including a first distal portion and a second proximal portion, the second proximal portion of the connector engagement member including a threaded interior section engaging the threaded exterior section of the central core to attach the connector engagement member to the central core, the first distal portion of the connector engagement member including a front wall configured to contact an interface portion of an end-of-arm tool connector of a robotic arm; and c) a driver assembly retainer member having a central opening extending along the handle assembly longitudinal axis, the driver retainer member securing a driver assembly of a shaft drive transmission within the through bore of the handle assembly and including a first distal portion and a second proximal portion, the first distal portion of the driver assembly retainer member including a threaded interior section engaging the threaded exterior section of the central core to attach the driver assembly retainer member to the central core.

In another aspect, the present disclosure related to a power operated trimming tool configured to be coupled to an interface portion of an end-of-arm tool connector of a robotic arm, the power operated trimming tool comprising: a) a head assembly including a frame body and a drive mechanism of the power operated trimming tool, the frame body supporting at least a portion of the drive mechanism and including a front portion and a proximal interface portion, the frame body proximal interface portion configured for coupling to an interface portion of an end-of-arm tool connector of a robotic arm; b) a handle assembly extending from the proximal interface portion of the frame body of the head assembly, the handle assembly including a through bore extending along a handle assembly longitudinal axis, the handle assembly through bore configured for receiving a driver assembly of a shaft drive transmission which is operatively coupled to the drive mechanism of the power operated trimming tool, the handle assembly includes: i) a central core extending along the handle assembly longitudinal axis and including a central through bore defining a portion of the handle assembly through bore, the central core including a first distal interface portion and a threaded exterior section, the first distal interface portion engaging the frame body proximal interface portion to attach the handle assembly to the frame body; and ii) a connector engagement member having a central opening extending along the handle assembly longitudinal axis and including a first distal portion and a second proximal portion, the second proximal portion of the connector engagement member including a threaded interior section engaging the threaded exterior section of the central portion of the central core to attach the connector engagement member to the central core, the first distal portion of the connector engagement member including a front wall configured to contact an interface portion of an end-of-arm tool connector of a robotic arm.

In another aspect, the present disclosure relates to a power operated rotary knife configured for coupling to an interface portion of an end-of-arm tool connector of a robotic arm, the power operated rotary knife comprising: a) a head assembly including a frame body and a drive mechanism of the power operated trimming tool, the frame body supporting at least a portion of the drive mechanism and including a front portion and a proximal interface portion, the frame body proximal interface portion configured for coupling to an interface portion of an end-of-arm tool connector of a robotic arm; b) a handle assembly extending from the proximal interface portion of the frame body of the head assembly, the handle assembly including a through bore extending along a handle assembly longitudinal axis, the handle assembly through bore configured for receiving a driver assembly of a shaft drive transmission which is operatively coupled to the drive mechanism of the power operated trimming tool, the handle assembly includes: i) a central core extending along the handle assembly longitudinal axis and including a central through bore defining a portion of the handle assembly through bore, the central core including a first distal interface portion and a threaded exterior section, the first distal interface portion engaging the frame body proximal interface portion to attach the handle assembly to the frame body; and ii) a driver assembly retainer member having a central opening extending along the handle assembly longitudinal axis, the driver retainer member including a first distal portion and a second proximal portion, the first distal portion of the driver assembly retainer member including a threaded interior section engaging the threaded exterior section of the central core to attach the driver assembly retainer member to the central core, the second proximal portion including a back wall configured to engage a driver assembly of a shaft drive transmission to secure a driver assembly within the through bore of the handle assembly.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic front perspective view of a first example or exemplary embodiment of a power operated trimming tool, such as a hand-held, power operated rotary knife, of the present disclosure, as mounted to an interface portion of an end-of-arm tool connector of a robotic arm, the power operated trimming tool including a head assembly and an elongated handle assembly extending from the head assembly, FIG. 1 also schematically depicting portions of a shaft drive transmission coupled to the handle assembly of the power operated trimming tool;

FIG. 2 is a schematic side elevation view of the power operated trimming tool of FIG. 1;

FIG. 3 is a schematic longitudinal section view of the power operated trimming tool of FIG. 1, a driver assembly of the shaft drive transmission being secured in a through bore of the handle assembly;

FIG. 4 is a schematic partially exploded front perspective view of the power operated trimming tool, the robotic arm and end-of-arm tool connector, and portions of the shaft drive transmission of FIG. 1;

FIG. 5 is a schematic view, partially in longitudinal section and partially in side elevation, of the power operated trimming tool, the robotic arm and end-of-arm tool connector, and portions of the shaft drive transmission of FIG. 1;

FIG. 6 is a schematic partially exploded front perspective view of the power operated trimming tool and the robotic arm and end-of-arm tool connector of FIG. 1;

FIG. 7 is a schematic partially exploded rear perspective view of the power operated trimming tool and the robotic arm and end-of-arm tool connector of FIG. 1;

FIG. 8 is a schematic front perspective view of a connector engagement member of the handle assembly of the power operated trimming tool of FIG. 1;

FIG. 9 is a schematic front elevation view of the connector engagement member of FIG. 8;

FIG. 10 is a schematic rear elevation view of the connector engagement member of FIG. 8;

FIG. 11 is a schematic longitudinal section view of the connector engagement member of FIG. 8, as seen from a plane indicated by the line 11-11 in FIG. 9;

FIG. 12 is a schematic front perspective view of a driver assembly retainer member of the handle assembly of the power operated trimming tool of FIG. 1;

FIG. 13 is a schematic front elevation view of the driver assembly retainer member of FIG. 12;

FIG. 14 is a schematic rear elevation view of the driver assembly retainer member of FIG. 12;

FIG. 15 is a schematic longitudinal section view of the driver assembly retainer member of FIG. 12, as seen from a plane indicated by the line 15-15 in FIG. 13;

FIG. 16 is a schematic front perspective view of a central core of the handle assembly of the power operated trimming tool of FIG. 1;

FIG. 17 is a schematic front elevation view of the central core of FIG. 16;

FIG. 18 is a schematic rear elevation view of the central core of FIG. 16;

FIG. 19 is a schematic longitudinal section view of the central core of FIG. 16, as seen from a plane indicated by the line 19-19 in FIG. 17;

FIG. 20 is a schematic top plan view of a frame body of the head assembly of the power operated trimming tool of FIG. 1;

FIG. 21 is a schematic back elevation view of the frame body of FIG. 20;

FIG. 22 is a schematic front perspective view of a second example or exemplary embodiment of a power operated trimming tool, such as a hand-held, power operated rotary knife, of the present disclosure, as mounted to an interface portion of an end-of-arm tool connector of a robotic arm, the power operated trimming tool including a head assembly and an elongated handle assembly extending from the head assembly, FIG. 22 also schematically depicting portions of a shaft drive transmission coupled to the handle assembly of the power operated trimming tool;

FIG. 23 is a schematic side elevation view of the power operated trimming tool of FIG. 22;

FIG. 24 is a schematic longitudinal section view of the power operated trimming tool of FIG. 22, a driver assembly of the shaft drive transmission being secured in a through bore of the handle assembly;

FIG. 24A is a schematic front elevation view of the power operated trimming tool of FIG. 22, as seen from a plane indicated by the line 24A-24A in FIG. 24;

FIG. 25 is a schematic partially exploded front perspective view of the power operated trimming tool, the robotic arm and end-of-arm tool connector, and portions of the shaft drive transmission of FIG. 22;

FIG. 26 is a schematic view, partially in longitudinal section and partially in side elevation, of the power operated trimming tool, the robotic arm and end-of-arm tool connector, and portions of the shaft drive transmission of FIG. 22;

FIG. 27 is a schematic partially exploded front perspective view of the power operated trimming tool and the robotic arm and end-of-arm tool connector of FIG. 22;

FIG. 28 is a schematic partially exploded rear perspective view of the power operated trimming tool and the robotic arm and end-of-arm tool connector of FIG. 22;

FIG. 29 is a schematic front, top perspective view of a product diverter of the head assembly of the head assembly of the power operated trimming tool of FIG. 22;

FIG. 30 is a schematic right side elevation view of the product diverter of FIG. 29;

FIG. 31 is a schematic right side elevation view of the product diverter of FIG. 29;

FIG. 32 is a schematic left side elevation view of the product diverter of FIG. 29;

FIG. 33 is a schematic front elevation view of the product diverter of FIG. 29;

FIG. 34 is a schematic rear elevation view of the product diverter of FIG. 29;

FIG. 35 is a schematic bottom plan view of the product diverter of FIG. 29;

FIG. 36 is a schematic top plan view of the product diverter of FIG. 29;

FIG. 37 is a schematic longitudinal, vertical section view of the product diverter of FIG. 29, as seen from a plane indicated by the lines 37-37 in FIG. 35; and

FIG. 38 is a schematic transverse, vertical section view of the product diverter of FIG. 29, as seen from a plane indicated by the line 38-38 in FIG. 35.

### DETAILED DESCRIPTION

The present disclosure relates to a hand-held, power operated trimming tool 1000, such as a hand-held, power operated rotary knife 1002 depicted in the Figures, which has been modified for mounting to an interface portion 164 of an end-of-arm tool connector 160 of a robotic arm 150 of a robotic arm assembly 100 thereby facilitating manipulation of the power operated trimming tool 1000 by the robotic arm assembly 100 for cutting and trimming purpose, as opposed to manual manipulation of the power operated trimming tool by a hand of a human operator. The power operated trimming tool 1000, in one exemplary embodiment, is the power operated rotary knife 1002, although it should be appreciated by those of skill in the art that the configuration of a handle assembly 1100 and the head assembly 1200 depicted herein are equally applicable to other power operated rotary trimming tools, such as, hand-held power operated skinning devices, as mentioned in the present application. For convenience, the following description will be directed to the depicted exemplary embodiment of the power operated rotary knife 1002, as representative of a class of hand-held, power operated trimming tools modified for mounting to an interface portion 164 of an end-of-arm tool connector 160 of a robotic arm assembly 100.

Advantageously, components of a handle assembly 1100 and a head assembly 1200 of the power operated rotary knife 1002 have been configured such that the power operated rotary knife 1002 is adapted for attachment to the interface portion 164 of the end-of-arm tool connector 160 of the robotic arm assembly 100. The end-of-arm tool connector 160 is coupled to a robotic arm 150 of the robotic arm assembly 100 thus advantageously allowing the robotic arm 150 to appropriately manipulate the power operated rotary knife 1002 for desired cutting and trimming operations by a cutting edge of the annular rotary knife blade 1300 of the knife 1002, for example, performing meat and fish cutting and trimming operations with the knife 1002. Further and advantageously, components of the handle assembly 1100 and the head assembly 1200 of the power operated rotary knife 1002 have been modified such that the power operated rotary knife 1002 is suitable for attachment or coupling to the end-of-arm tool connector 160 are designed either to be used as dual function components (e.g., a frame body 1250 of the head assembly 1200) or to be readily replaced by other components of the handle assembly 1100 of the power operated rotary knife 1002 such that the power operated rotary knife may be readily converted from the configuration showing in the drawing Figures, for attachment to an end-of-arm tool connector of a robotic arm suitable for robotic manipulation of the power operated rotary knife, to a configuration of the power operated rotary knife 1002, suitable for manual manipulation of the power operated rotary knife 1002 by a human operator.

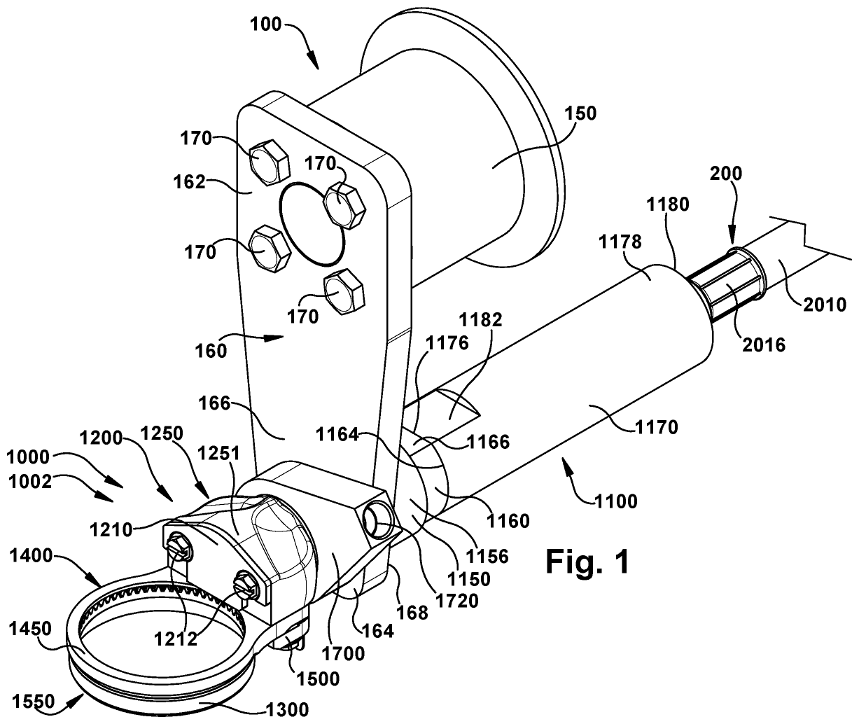

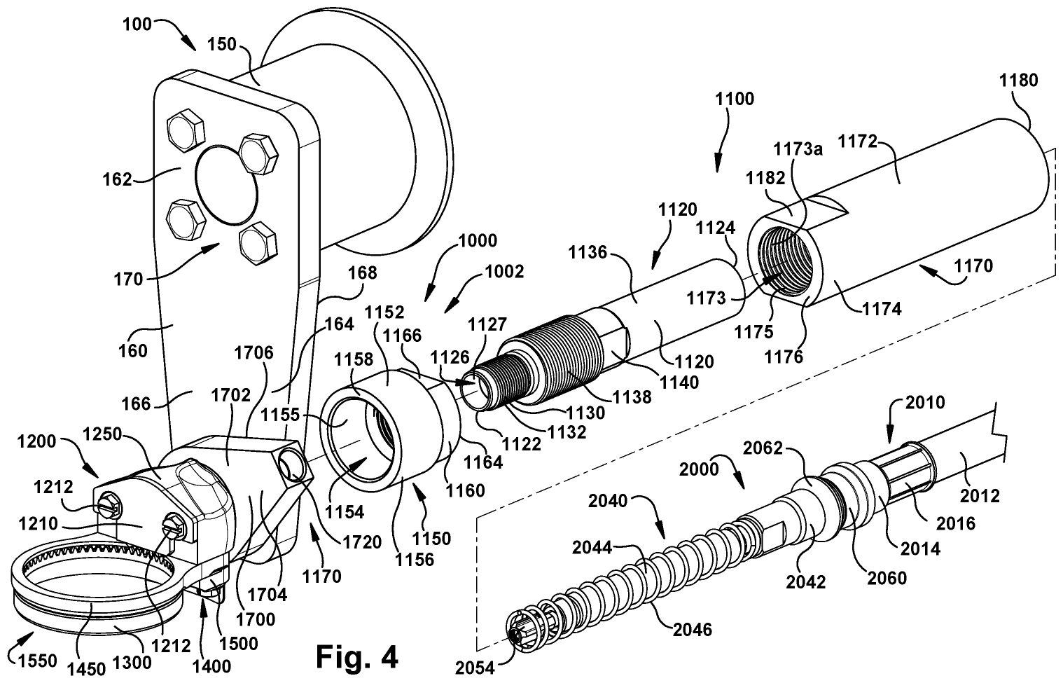

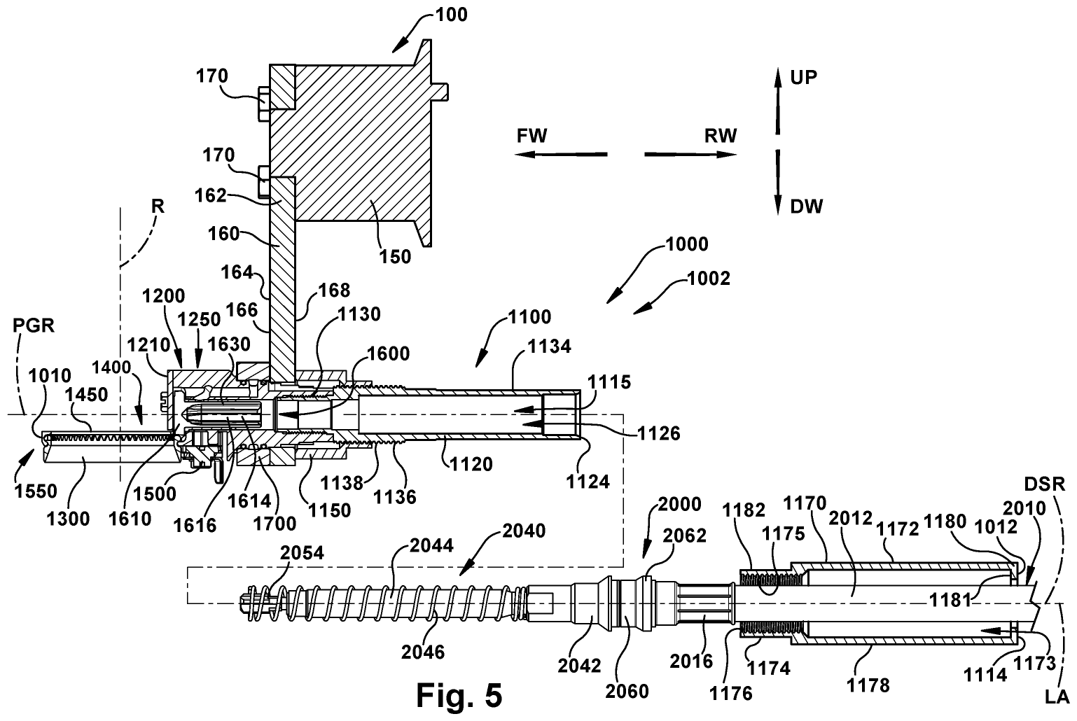

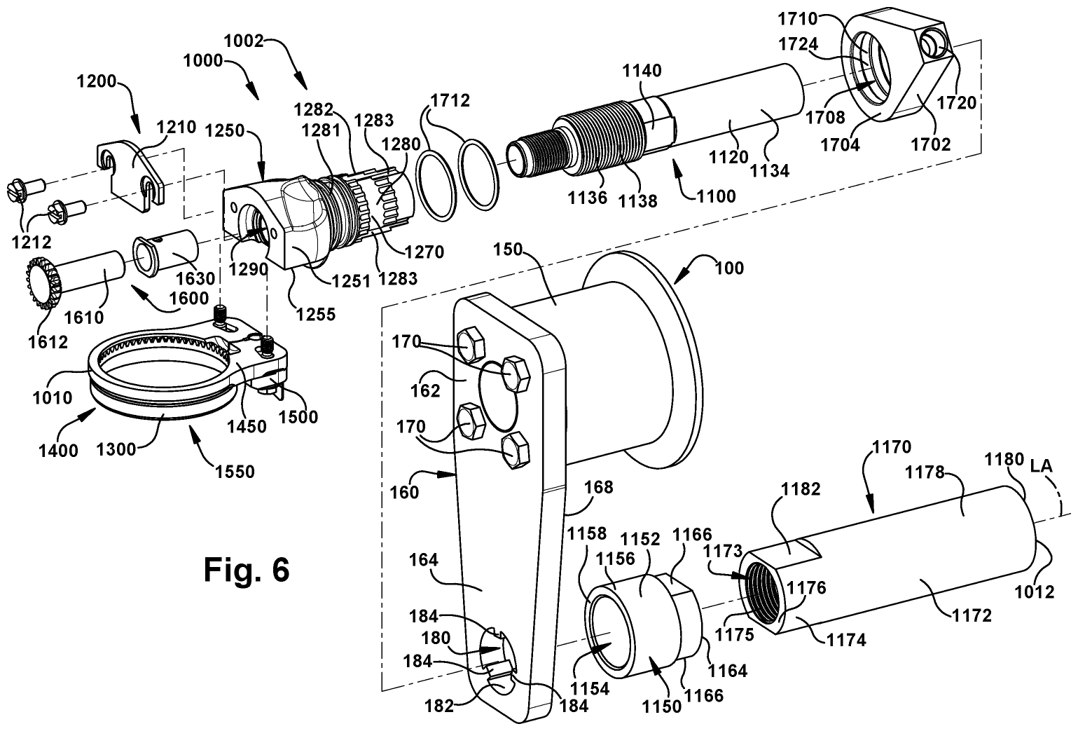

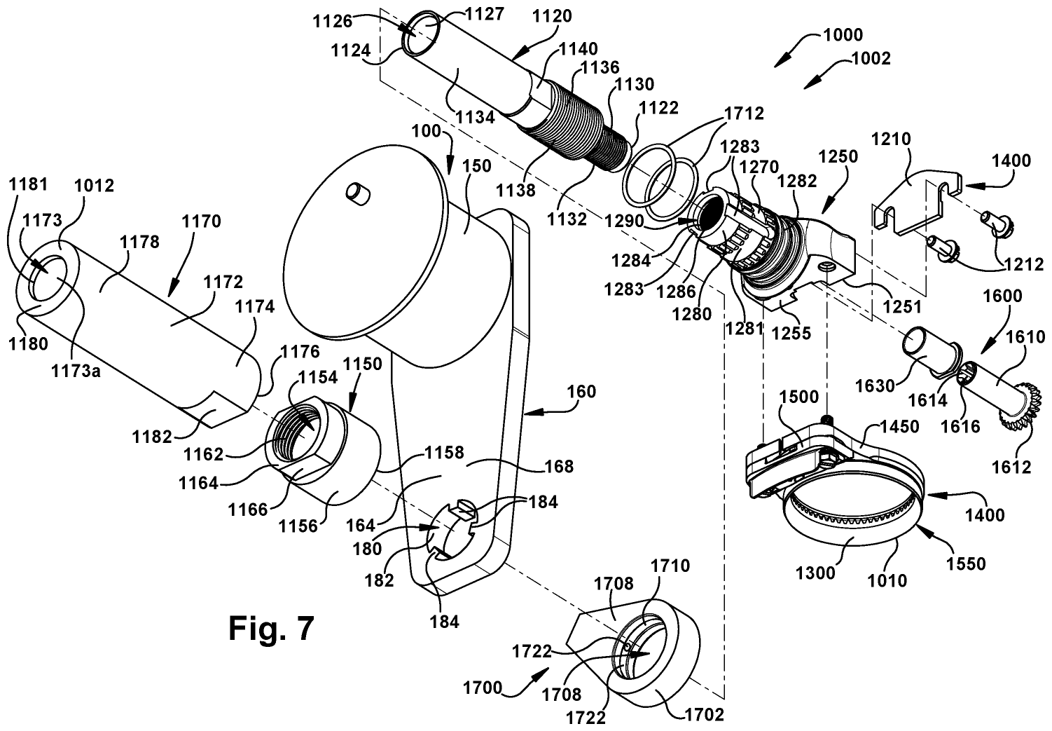

As schematically depicted in FIGS. 1-7, the robotic arm assembly 100 includes an end-of-arm tool connector 160 which is operatively coupled to a robotic arm 150. The end-of-arm tool connector 160 includes an upper portion 162, which is affixed to the robotic arm 150 by a mechanical connection 170, and a lower or interface portion 164, which is affixed to the power operated rotary knife 1002. The lower interface portion 164 includes a front wall or front surface 166, facing in the forward or distal direction FW, and a back wall or back surface 268, facing in a rearward or proximal direction RW. The lower interface portion 164 includes an opening through bore 180 defined by an inner surface 182. The inner surface 182 includes three radially inwardly extending tabs 184 which interfit into or are received in three corresponding longitudinally extending grooves 1283 of an outer surface 1272 of a generally cylindrical or annular boss 1280 of a handle assembly interface portion 1270 of a rearward or proximal portion 1252 of the frame body 1250 of the head assembly 1200.

Power Operated Rotary Knife 1002

In a first example or exemplary embodiment, the power operated trimming tool 1000 of the present disclosure is the power operated rotary knife 1002, as schematically depicted in FIGS. 1-7. The power operated rotary knife 1002 extends between a distal or working end 1010 of the knife 1002 and a proximal end 1012 and includes the head assembly 1200 and the elongated handle assembly 1100. The handle assembly 1100 is releasably attached to and extends along a handle assembly central or longitudinal axis LA from the handle assembly interface portion 1270 of the rearward or proximal portion 1252 of the frame body 1250 of the head assembly 1200. The handle assembly 1100 extends between a distal end 1112 and a proximal end 1114, which also is the proximal end 1012 of the power operated rotary knife 1002. The handle assembly 1100 includes a central through bore 1115, which extends along and is centered about the handle assembly longitudinal axis LA. The handle assembly central through bore 1115 is sized to receive a distal driver assembly 2040 of a shaft drive transmission 2000 that provides rotational power to a drive mechanism 1600 of the power operated rotary knife 1002.

Head Assembly 1200

In one exemplary embodiment and as best seen in FIGS. 1-7, the head assembly 1200 includes the frame body 1250, a blade housing assembly 1400, the annular rotary knife blade 1300 which is driven for rotation about a blade central axis of rotation R, and the drive mechanism 1600 for rotating the annular rotary knife blade 1300. The frame body 1250 supports the blade housing assembly 1400 which, in turn, supports the annular rotary knife blade 1300 for rotation about the central axis of rotation R. The lower cutting edge of the annular rotary knife blade 1300 defines a cutting plane CP of the power operated rotary knife 1002. The cutting plane CP is orthogonal to the blade axis of rotation R and parallel to and disposed below (that is, in the downward direction DW from) the handle assembly longitudinal axis LA. Each of the cutting plane CP, the blade central axis of rotation R, and the handle assembly longitudinal axis LA lie along or are coincident with a central vertical plane CVP of the power operated rotary knife 3002. An assembled combination of the annular rotary knife blade 1300, as rotatably supported by a split blade housing 1450 of the blade housing assembly 1400, is referred to as an assembled blade-blade housing combination 1550. The drive mechanism 1600 is at least partially supported by and disposed within the frame body 1250. The drive mechanism 1600 is operatively coupled to and rotates the annular rotary knife blade 1300 about the blade axis of rotation R. The directions up UP and down DW, as used herein are parallel to a direction of the blade axis of rotation R.

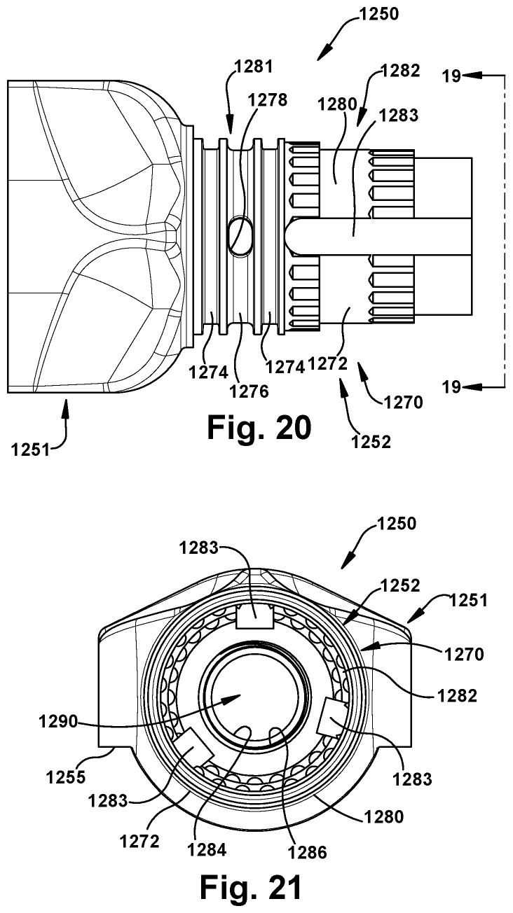

As best seen in FIGS. 20 and 21, the frame body 1250 includes a central through bore or opening 1290 centered about and extending along the handle assembly longitudinal axis LA and further includes an enlarged forward or distal portion 1251 and the generally cylindrical rearward or proximal portion 1252 extending from the enlarged forward portion 1251. The forward portion 1251 of the frame body 1250 includes a lower planar surface 1255 which serves as a mounting pedestal for the blade housing assembly 1400. The rearward portion 1252 of the frame body 1250 includes the handle assembly interface portion 1270 which receives and/or supports: a) an annular body 1702 of a lubrication assembly 1700 which routes lubrication through the frame body 1250 to the drive mechanism 1600; b) the interface portion 164 of the end-of-arm tool connector 160 of the robotic arm assembly 100; and c) a generally cylindrical central core 1120 of the handle assembly 1100.

As best seen in FIG. 20, the rearward or proximal handle assembly interface portion 1270 of the frame body 1250 of the head assembly 1200 includes a proximal end 1260 of the frame body 1250 and comprises the generally cylindrical or annular boss 1280. The annular boss 1280 includes a rearward portion of the frame body central opening 1290 defined by an inner surface 1284 of the annular boss 1280. A forward or distal section 1281 of the annular boss 1280 of the frame body supports the lubrication assembly 1700. Specifically, an outer surface 1272 of the annular boss 1280 in the distal section 1281 includes a pair of circumferential slots 1274 spaced apart longitudinally (that is, as viewed with respect to the handle assembly longitudinal axis LA) by a circumferential lubrication channel 1276. The pair of circumferential slots 1274 receive a pair of o-rings 1712 of the annular body 1702 of the lubrication assembly 1700. The pair of o-rings 1712 are disposed between the pair of circumferential slots 1274 of the outer surface 1272 of the annular boss 1280 and a matching pair/set of slots formed on an inner surface 1710 of a through bore 1708 of the annular body 1702 of the lubrication assembly 1700. The pair of o-rings 1712 bound the circumferential lubrication channel 1276 of the outer surface 1272 to mitigate leaking of lubricant communicated by the annular body 1702 to the lubrication channel 1276. The lubrication channel 1276 includes a lubrication orifice 1278 which is part of an interior passageway defined by the frame body 1250 to route lubrication from the lubrication assembly 1700 to the drive mechanism 1600.

A rearward or proximal section 1282 of the annular boss 1280 includes the set of three longitudinally extending, circumferentially spaced grooves 1283 formed in the outer surface 1272 of the annular boss 1280 of the handle assembly interface portion 1270 that receive the three radially inwardly extending tabs 184 of the inner surface 182 of the through bore 180 of the end-of-arm tool connector lower portion 164 to facilitate mounting or coupling of the power operated rotary knife 1002 to the end-of-arm tool connector 160. The rearward section 1282 of the annular boss 1280 also includes a threaded proximal portion 1286 of an inner surface 1284 defining a portion of the central opening 1290 of the frame body 1250. The threaded inner surface portion 1286 of the annular boss 1280 receives and engages a mating threaded outer surface 1132 of a forward or distal, reduced diameter, frame body interface portion 1130 of the central core 1120 of the handle assembly 1100 to attach the handle assembly 1100 to the handle assembly interface portion 1270 of the head assembly 1200.

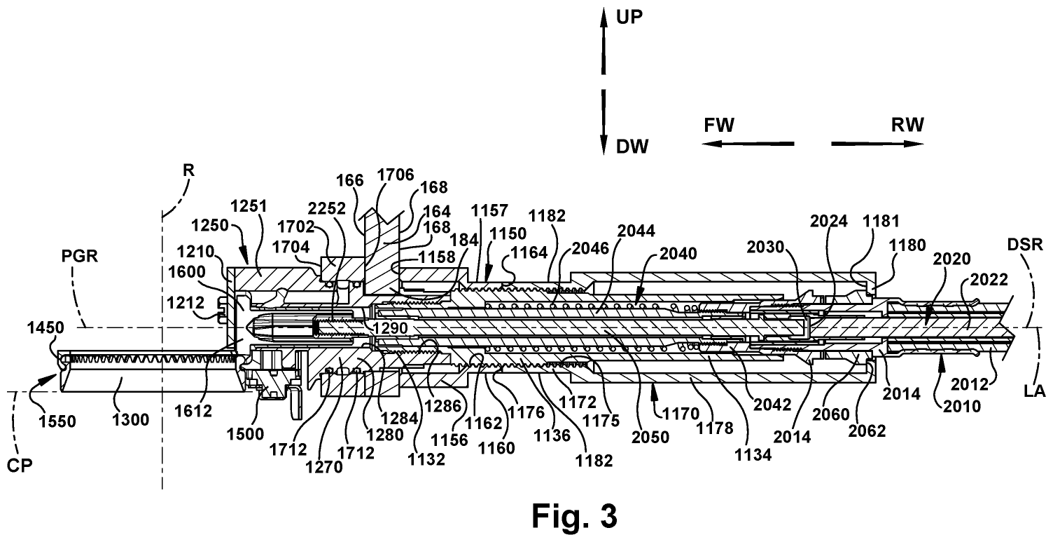

As best seen in FIGS. 3, 6 and 7, the head assembly 1200 further includes the blade housing assembly 1400, mounted to the lower planar surface 1255 of the frame body 1250. The blade housing assembly 1400 includes the split blade housing 1450 and a cam mechanism 1500 engaging a mounting portion of the split blade housing 1450 to move the split blade housing 1450 between a blade supporting position, wherein the annular rotary knife blade 1300 is supported for rotation about its axis of rotation R and a blade changing position, wherein the annular rotary knife blade 1300 may be removed from the split blade housing 1450 for blade changing or blade sharpening purposes. Details of the blade housing assembly 1400, including the cam mechanism 1500, are disclosed in aforementioned U.S. Pat. No. 10,471,614 to Whited et al., which is assigned to the assignee of the present application and which is incorporated by reference herein in its entirety.

The head assembly 1200 further includes the lubrication assembly 1700 which includes the annular body 1702. The annular body 1702 is rotatably mounted on the forward or distal section 1281 of the annular boss 1280. The annular body 1702 includes a front wall 1704 facing toward the forward portion 1251 of the frame body 1250 and a back or rear wall 1706 which abuts and contacts the front wall 166 of the lower portion 164 of the end-of-arm tool connector 160 adjacent the through bore 180 of the connector 160. The mounting of the power operated rotary knife 1002 is advantageously secured by both longitudinal and radial engagement between the power operated rotary knife 1002 and the lower interface portion 164 of the end-of-arm connector 160. Specifically, securement between the power operated rotary knife 1002 and the lower interface portion 164 of the end-of-arm connector 160 is accomplished by the following: a) abutting contact or engagement between the back wall or surface 1706 of the annular body 1702 of the lubrication assembly 1700 and the front wall 166 of the lower portion 164 of the end-of-arm tool connector 160 adjacent the through bore 180 of the connector 160; b) abutting contact or engagement between a front or forward wall 1158 of a distal portion 1156 of an annular body 1152 of a connector engagement member 1150 of the handle assembly 1100 and the back wall 168 of the lower portion 164 of the end-of-arm tool connector 160 adjacent the through bore 180 of the connector 160; and c) abutting contact or engagement between the three radially inwardly extending tabs 184 of the inner surface 182 defining the connector through bore 180 and the three grooves 1283 of the rearward section 1282 of the annular boss 1280 of the interface portion 1270 of the frame body 1250. Parts (a) and (b) noted above constitute engagement or contact along the handle assembly longitudinal axis LA and part (c) note above constitutes radial engagement or contact with respect to the handle assembly longitudinal axis LA that inhibits rotation of the power operated rotary knife 1002 about the longitudinal axis LA within the through bore 180 of the end-of-arm tool connector 160.

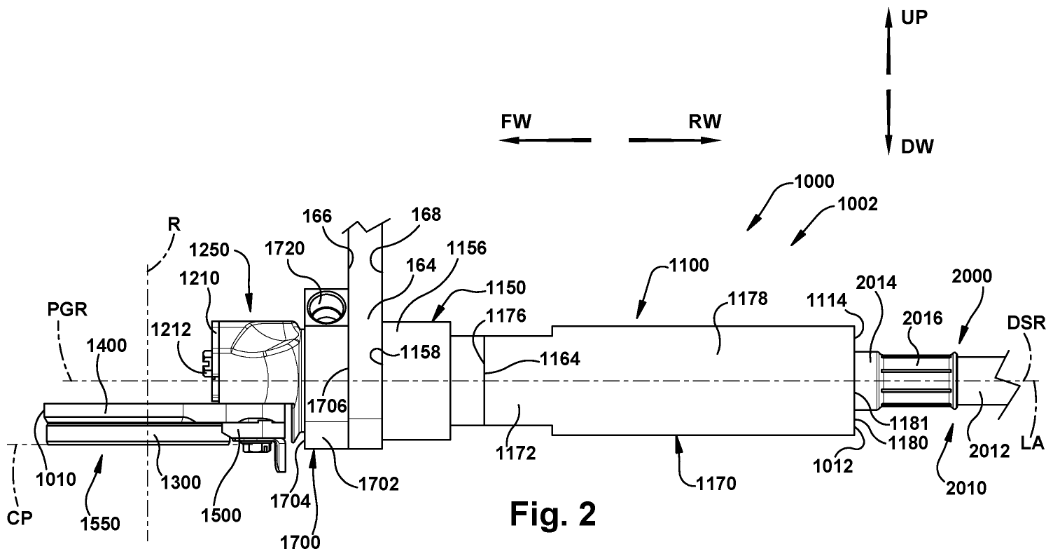

As best seen in FIGS. 2, 3 and 5, when the handle assembly 1100 is secured to the head assembly 1200, there is contact between: a) the back wall or surface 1706 of the annular body 1702 of the lubrication assembly 1700 and the front wall 166 of the lower portion 164 of the end-of-arm tool connector 160 adjacent the through bore 180 of the connector 160; and b) the forward wall 1158 of the distal portion 1160 of the annular body 1152 of the connector engagement member 1150 of the handle assembly 1100 and the back wall 168 of the lower portion 164 of the end-of-arm tool connector 162 adjacent the through bore 180 of the connector 160. Thus, the lower portion 164 of the end-of-arm tool connector 160 is sandwiched between the facing back wall 1706 of the annular body 1702 and the forward wall 1158 of the distal portion 1156 of the annular body 1152 of the connector engagement member 1150 of the handle assembly 1100. Further, the abutting contact between the four surfaces 1706, 166, 1158, 168 causes the annular body 1702 to become fixed in circumferential position with respect to the frame body 1250, that is, the annular body 1702 is no longer rotatable about the frame body annular boss 1280.

The annular body 1702 of the lubrication assembly 1700 further includes the two o-rings 1712 which are seated in circumferential slots formed on the inner surface 1710 of the annular body 1702. The annular body 1702 includes a lubrication receiving port 1720, for the input of lubricant to the annular body 1702, which is in fluid communication with a lubrication transmitting orifice 1722 opening into the annular lubrication channel 1724 of the inner surface 1710 of the annular body 1702. The lubrication channel 1724 of the annular body 1702 faces the lubrication channel 1276 of the annular boss 1280 of the frame body 1250. The annular lubrication channels 1724, 1276 fill with lubricant which then traverses through the frame body annular boss lubrication orifice 1278, which is part of an interior passageway defined by the frame body 1250 to route lubrication from the lubrication assembly 1700 to the drive mechanism 1600 of the power operated rotary knife 1002. Details of the lubrication assembly 1700 are disclosed in aforementioned U.S. Pat. No. 9,522,473 to Mascari et al., which is assigned to the assignee of the present application and which is incorporated by reference herein in its entirety.

The forward or distal portion 1251 of the frame body 1250 supports the drive mechanism 1600, which, in one exemplary embodiment, includes a drive gear 1610, such as a pinion gear. The pinion gear 1610 includes a gear head 1612 that engages a set of gear teeth of the annular rotary knife blade 1300 to rotate the blade 1300 about the blade central axis of rotation R. Extending in the rearward direction RW from the gear head 1612 of the pinion gear 1610 is a hollow shaft 1614 that defines a socket-like driven fitting 1616. The driven fitting 1616 defined by the shaft 1614 of the pinion gear 1610 receives a drive fitting 2054 of the driver assembly 2040 of the shaft drive transmission 2000. The pinion gear 1610 is supported for rotation about a pinion gear axis of rotation PGR by a sleeve bushing 1630 supported by the through bore 1290 of the frame body 1250. The drive fitting 2054 is coupled to a distal end of a driver shaft 2050 of the driver assembly 2040. As the driver shaft 2050 is driven for rotation about the drive shaft axis of rotation DSR, the drive fitting 2054 of the driver shaft 2050 engages driven fitting 1616 of the pinion gear 1610 and rotates the pinion gear 1610 about the pinion gear axis of rotation PGR. In one exemplary embodiment, as seen in FIGS. 2, 3 and 5, the pinion gear axis of rotation PGR, the drive gear axis of rotation DSR and the handle assembly central longitudinal axis LA are aligned or coincident. Forming a forward facing wall of the forward portion 1251 of the frame body 1250 adjacent the pinion gear gear head 1612 is a pinion gear cover 1210. The pinion gear cover 1210 is secured to the forward portion 1251 of the frame body 1250 by a pair of threaded fasteners 1212.

Shaft Drive Transmission 2000

As best seen in FIGS. 3-5, the shaft drive transmission 2000 provides motive power to rotate the drive mechanism pinion gear 1610, which, in turn, engages and rotates the annular rotary knife blade 1300. A proximal end (not shown) of the shaft drive transmission 2000 is coupled to an external motor (not shown) which rotates a flexible drive transmitting shaft 2022 of a drive shaft assembly 2020 of the shaft drive transmission. In one exemplary embodiment, the shaft drive transmission 2000 includes the drive shaft assembly 2020 supported within a flexible outer casing assembly 2010. The shaft drive transmission 2000 further includes the driver assembly 2040 which is received within the handle assembly through bore 1115 and engages the drive mechanism 1600 of the power operated rotary knife 1002 to rotate the rotary knife blade 1300 about its axis of rotation R, as explained above. The drive shaft assembly 2020 includes the flexible drive transmitting shaft 2022 having a flex shaft fitting 2030 coupled to a distal end of the drive transmitting shaft 2022. The outer casing assembly 2010 of the shaft drive transmission 2000 includes the outer casing 2012 enclosing and supporting the drive transmitting shaft 2022 for rotation, the outer casing assembly 2010 does not rotate with the shaft 2022.

At a distal end of the outer casing 2012 is a drive assembly coupling 2014 and a stress relief sleeve 2016 to mitigate kinking of the outer casing 2012 in the region of the handle assembly 1100 of the power operated rotary knife 1002. The driver assembly coupling 2014 is threaded coupled to a casing coupler 2042 of the driver assembly 2040 to releasably affix the driver assembly 2040 to the outer casing assembly 2010. The driver assembly 2040 includes a tube 2044 and a biasing spring 2046 which biases or urges the driver assembly 2040 in the rearward direction RW. The driver shaft 2050 is supported by a bearing assembly disposed within the tube 2044. A driven fitting 2252 at a proximal end of the driver shaft 2050 engages the flex shaft fitting 2030 at the distal end of the drive transmitting shaft 2022 such that the driver shaft 2050 rotates in unison with the drive transmitting shaft 2022. At a distal end of the driver shaft 2050 is the drive fitting 2054 which, as explained previously, engages and rotates the pinion gear driven fitting 1616 about the pinion gear axis of rotation PGR. The driver assembly 2040 further includes a latch collar 2060 adjacent the casing coupler 2042. The latch collar 2060 includes a shoulder 2062 that bears against a radially inwardly step or shoulder 1181 of a back or end wall 1180 of an enlarged diameter proximal portion 1178 of a driver assembly retainer member 1170 of the handle assembly 1100 to secure and position the driver assembly 2040 within the handle assembly through bore 1115.

Details of the shaft drive transmission 2000 and driver assembly 2040 are disclosed in U.S. Pat. No. 9,265,263 to Whited et al., which is assigned to the assignee of the present application and which is incorporated by reference herein in its entirety.

Handle Assembly 1100

In one exemplary embodiment and as best seen in FIGS. 1-7, the handle assembly 1100 includes the generally cylindrical central core 1120 overlied by the generally cylindrical connector engagement member or connector engagement collar 1150 and the generally cylindrical driver assembly retainer member or collar 1170. The connector engagement member 1150 and the driver assembly retainer member 1170, in one exemplary embodiment, threadedly engage a threaded outer surface 1138 of a central portion 1136 of the central core 1120 to affix the connector engagement member 1150 and the driver assembly retainer member 1170 to the central core 1120. The central core 1120, in turn, includes the threaded outer surface 1132 in the forward, reduced diameter, frame body interface portion 1130 of the central core 1120. In one exemplary embodiment, the threaded outer surface 1132 of the forward, reduced diameter, frame body interface portion 1130 threadedly engages a threaded proximal portion 1286 of the inner surface 1284 of the cylindrical annular boss 1280 of the frame body 1250 to secure the central core 1120, and, therefore, the handle assembly 1100 to the frame body 1250.

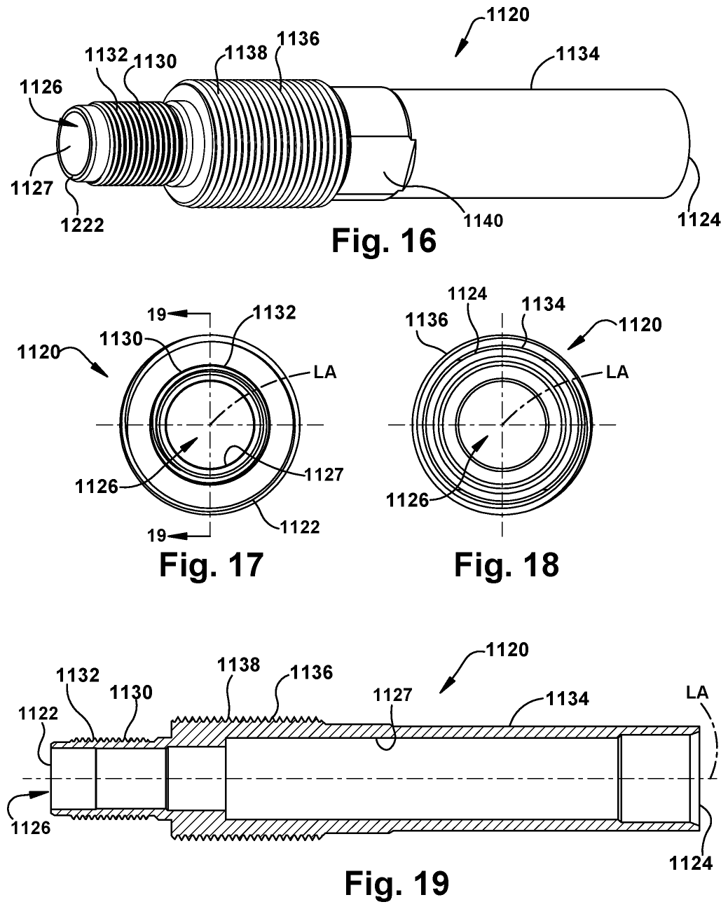

As best seen in FIGS. 16-19, the central core 1120 of the handle assembly 1100 extends between a distal end 1122 and a proximal end 1124 and includes a central opening or through bore 1126 extending along the handle assembly central axis LA. The through bore 1126 is defined by an inner surface 1127 and is generally cylindrical, defining a portion of the handle assembly through bore 1115. In one exemplary embodiment, the central core 1120 includes the forward, reduced diameter, frame body interface portion 1130 including the threaded outer surface 1132, the enlarged diameter, central portion 1136 including the threaded outer surface 1138, and a proximal portion 1134. The distal interface portion 1130 of the central core 1120 is advantageously of smaller diameter to insure it is of sufficiently small diameter for the threaded outer surface 1132 to be received within the threaded inner surface 1286 of the rearward section 1282 of the cylindrical annular boss 1280 of the frame body 1250. By contrast, the central and proximal portions 1136, 1134 of the central core 1120 have an enlarged diameter, thereby, defining a larger diameter handle assembly through bore 1115 to accommodate the diameter of the tube 2044 of the driver assembly 2040 into the handle assembly throughbore 1115.

Advantageously, the threaded outer surface 1138 of the central portion 1136 functions to facilitate securement of both the connector engagement member 1150 of the handle assembly 1100 and the driver assembly retainer member 1170 of the handle assembly 1100 to the central core 1120. Specifically, the connector engagement member 1150 includes a threaded inner surface 1162 of a central opening or through bore 1154 which threadedly engages the threaded outer surface 1138 of the central portion 1136 to secure the connector engagement member 1150 to the central core 1120. Similarly, the driver assembly retainer member 1170 includes a threaded inner surface 1175 of a distal portion 1174 of the member 1170 which threadedly engages the threaded outer surface 1138 of the central portion 1136 to secure the driver assembly retainer member 1170 to the central core 1120. In one exemplary embodiment, a forward wall 1176 of the driver assembly retainer member 1170 contacts or engages a back wall 1164 of a reduced diameter proximal portion 1160 of the connector engagement member 1150 to limit the extend of forward travel of the driver assembly retainer member 1170 with respect to the central core 1120. A non-threaded portion of the outer surface of the central portion 1136 includes opposing flats 1140 to allow for tightening the central core 1120 into the frame body annular boss 1280 using a conventional end wrench.

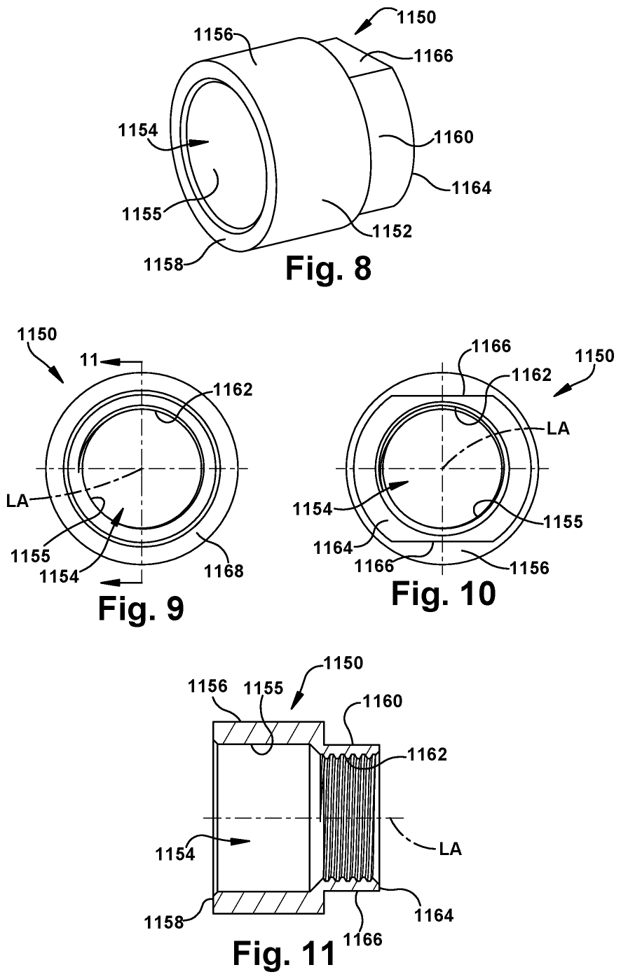

As best seen in FIGS. 8-11, the connector engagement member or collar 1150 abuts the back wall 168 of the lower interface portion 164 of the end-of-arm tool connector 160 in the region of the through bore 180 of the connector 160 and thus advantageously functions as part of the securement structure that secures the power operated rotary knife 1002 to the end-of arm tool connector 160. In one exemplary embodiment, the connector engagement member 1150 comprises the stepped annular body 1152 that extends between the forward wall or end 1158 and the back wall or end 1164. As the connector engagement member 1150 overlies and is threadedly coupled to the central core 1120, as explained previously and as best seen in FIG. 3, the inner and outer diameters of the connector engagement member 1150 are necessarily greater than the corresponding inner and outer diameters of the central core 1120. The annular body 1152 of the connector engagement member 1150 includes the central opening or through bore 1154 (best seen in FIG. 11) defined by an inner surface 1155. The through bore 1154 extends along and is centered about the handle assembly longitudinal axis LA.

The connector engagement member 1150 is stepped in that the annular body 1152 includes an enlarged diameter distal portion 1156 and the reduced diameter proximal portion 1160. The forward wall 1158 of the enlarged diameter distal portion 1156 of the connector engagement member 1150 engages the back wall 168 of the lower interface portion 164 of the end-of-arm connector 160. Advantageously, the enlarged diameter distal portion 1156 defines a similarly enlarged section of the through bore 1154 that is sufficiently large in diameter to: a) provide for clearance with respect to the outer diameter of the rearward section 1282 of the cylindrical annular boss 1280 of the frame body 1250; and b) provide for a 360 degree annulus or annular region of contact between the forward wall 1158 of the enlarged diameter distal portion 1156 of the connector engagement member 1150 and the back wall 168 of the lower interface portion 164 of the end-of-arm connector 160, that is, a circular ring of contact between the respective forward and back walls 1158, 168 of the connector engagement member 1150 and the end-of-arm tool connector 160 that is radially outward of the through bore 180 of the end-of-arm tool connector 160.

As mentioned previously, the threaded inner surface 1162 of the through bore 1154 in the reduced diameter proximal portion 1160 threads into the threaded outer surface 1138 of the central portion 1136 of the central core 1120 to secure the connector engagement member 1150 to the central core 1120. Since the back wall 1164 of the reduced diameter proximal portion 1160 engages or abuts the front wall 1176 of a distal portion 1174 of the driver assembly retainer member 1170, advantageously, the connector engagement member 1150 limits the extent of travel of the driver assembly retainer member 1170 in the forward direction FW with respect to the central core 1120. Stated another way, the connector engagement member 1150 is constrained from movement in the forward direction FW with respect to the central core 1120 by abutting contact with the back wall 168 of the end-of-arm tool connector 160 and is constrained from movement in the rearward direction RW by abutting contact with the front wall 1176 of the driver assembly retainer member 1170. A portion of the outer surface of the reduced diameter proximal portion 1160 adjacent the back or rear wall 1164 of the connector engagement member 1150 includes opposing flats 1140 to allow for tightening the connector engagement member 1150 onto the threaded outer surface 1138 of the central portion 1136 of the central core 1120.

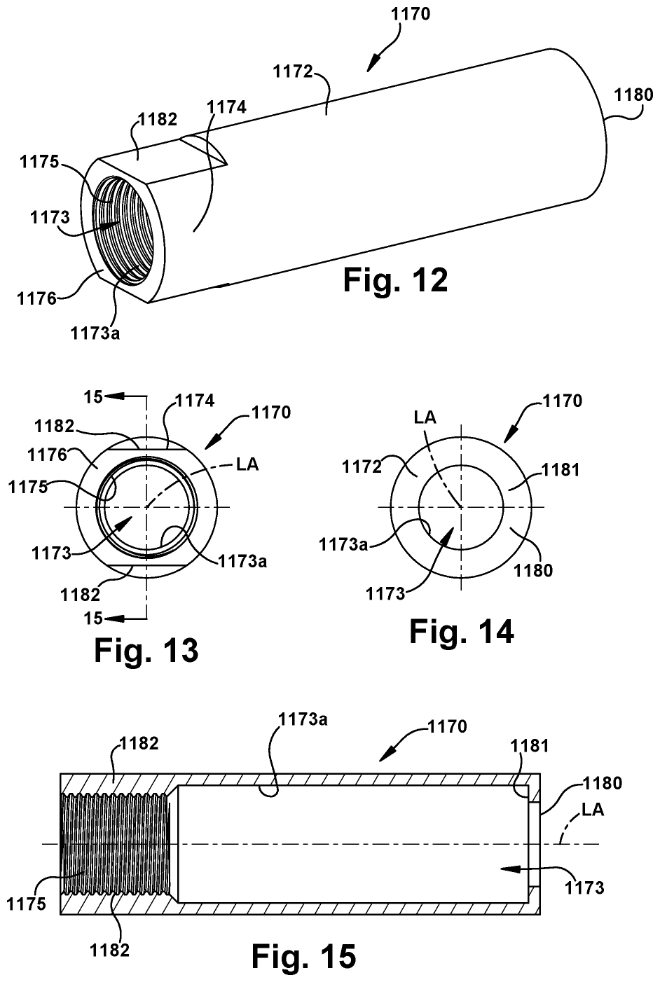

As best seen in FIGS. 12-15, the driver assembly retainer member or collar 1170 abuts the back wall 1164 of the reduced diameter proximal portion 1160 of the connector engagement member 1150 and functions to secure and position the driver assembly 2040 of the shaft drive transmission 2000 within the handle assembly central through bore 1115 so that the driven fitting 2054 of the driver assembly 2040 engages the driven fitting 1616 of the pinion gear 1610 to rotate the pinion gear 1610 about the pinion gear axis of rotation PGR. In one exemplary embodiment, the driver assembly retainer member 1170 comprises a cylindrical body 1172 that extends between the forward wall or end 1176 and a back wall or end 1180. As the driver assembly retainer member 1170 overlies and is threadedly coupled to the central core 1120, as explained previously and as best seen in FIG. 3, the inner and outer diameters of the driver assembly retainer member 1170 are necessarily greater than the corresponding inner and outer diameters of the central core 1120. The cylindrical body 1172 of the driver assembly retainer member 1170 includes the central opening or through bore 1173 (best seen in FIG. 15) defined by an inner surface 1173a. The through bore 1173 extends along and is centered about the handle assembly longitudinal axis LA.

The driver assembly retainer member 1170 includes the distal portion 1174 having the threaded inner surface 1175, which is a section of the inner surface 1173a of the annular body 1172 and which threadedly engages the threaded outer surface 1138 of the central portion 1136 to secure the driver assembly retainer member 1170 to the central core 1120. As previously explained, the forward wall 1176 of the distal portion 1174 of the driver assembly retainer member 1170 abuts or engages the back wall 1164 of the reduced diameter proximal portion 1160 of the connector engagement member 1150. The driver assembly retainer member 1170 also includes the proximal portion 1178, which, as best seen in FIG. 3, in the region of the back wall 1180, defines a rear portion of the handle assembly throughbore 1115 (the central core 1120 defining the remainder of the handle assembly throughbore 1115).

The proximal portion 1178 of the cylindrical body 1172 of the driver assembly retainer member 1170 includes the back or end wall 1164. The back wall 1164 of the driver assembly retainer member 1170 includes the radially inwardly extending step or shoulder 1181 which, as best seen in FIG. 3, advantageously engages the shoulder 2062 of the latch collar 2060 of the driver assembly 2040 to maintain and position the driver assembly 2040 within the handle assembly through bore 1115. A portion of the outer surface of the cylindrical body 1172 adjacent the forward wall 1176 of the distal portion 1174 of the reduced diameter proximal portion 1160 of the driver assembly retainer member 1170 includes opposing flats 1182 to allow for tightening the driver assembly retainer member 1170 onto the threaded outer surface 1138 of the central portion 1136 of the central core 1120. Advantageously, the annulus or circular ring defined by the forward wall 1176 of the distal portion 1174 of the driver assembly retainer member 1170 matches the annular or circular ring defined by the back wall 1164 of the reduced diameter proximal portion 1160 of the connector engagement member 1150 for secure abutting engagement and positioning of the two members 1150, 1170 along the central core 1120. As noted previously, contact of the annuluses defined by the forward wall 1176 and the back wall 1164 results in the connector engagement member 1150 limiting the extent of travel of the driver assembly retainer member 1170 in the forward direction FW with respect to the central core 1120 thereby insuring precise positioning of the driver assembly 2040 within the central core 1120.

The handle assembly 1100 and head assembly 1200 of the power operated rotary knife 1002 may be converted from a first configuration suitable for mounting to the end-of-arm tool connector 160 of a robotic arm assembly 100, as shown in FIGS. 1-7, for manipulation of the power operated rotary knife 1002 by the robotic arm 150 to a second configuration including a handle assembly including a conventional hand grip or hand piece suitable for manipulation by the hand of a human operator of the power operated rotary knife. Specifically and advantageously, the head assembly 1200, including the frame body 1250, need no changes or modifications for conversion from the first configuration to the second configuration and vice versa. For example, three longitudinally extending grooves 1283 of the outer surface 1272 of the cylindrical annular boss 1280 of the handle assembly interface portion 1270 of the frame body 1250 are suitable to be used in the first and second configurations. With regard to the handle assembly 1100 of the power operated rotary knife 1002, it would only be necessary to remove and replace the components 1120, 1150, 1170 of the handle assembly 1100 with a conventional handle assembly core, overlying hand-graspable hand piece and releasable driver assembly retainer at a proximal end of the hand piece, such as the handle assembly disclosed in, for example, the aforementioned and incorporated by reference U.S. Pat. No. 10,040,211 to Whited, to effect the conversion of the power operated rotary knife 1002 from the first configuration to the second configuration.

Second Exemplary Embodiment 3000

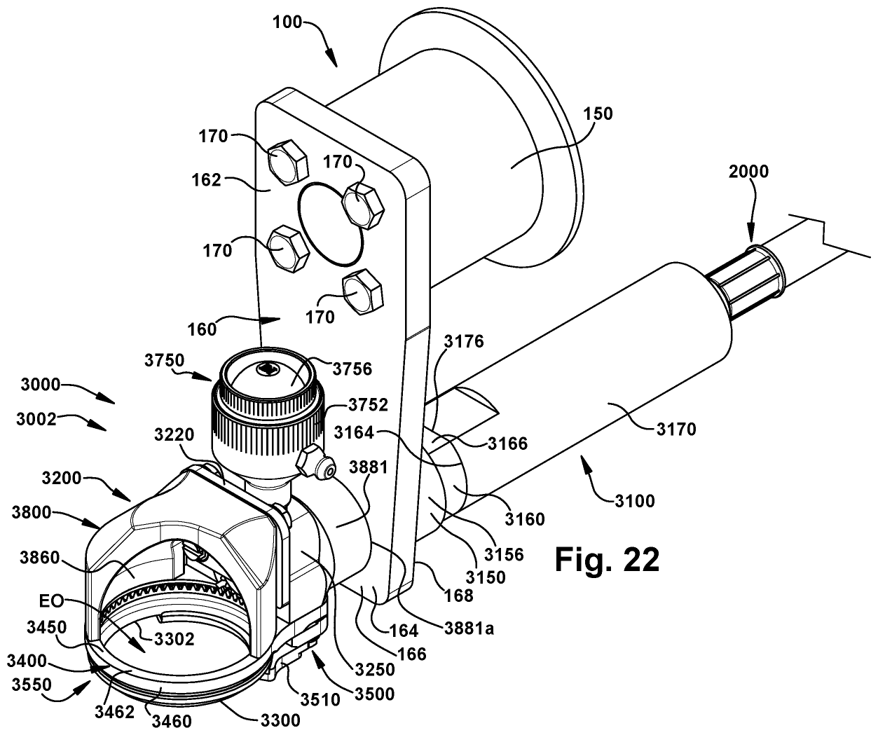

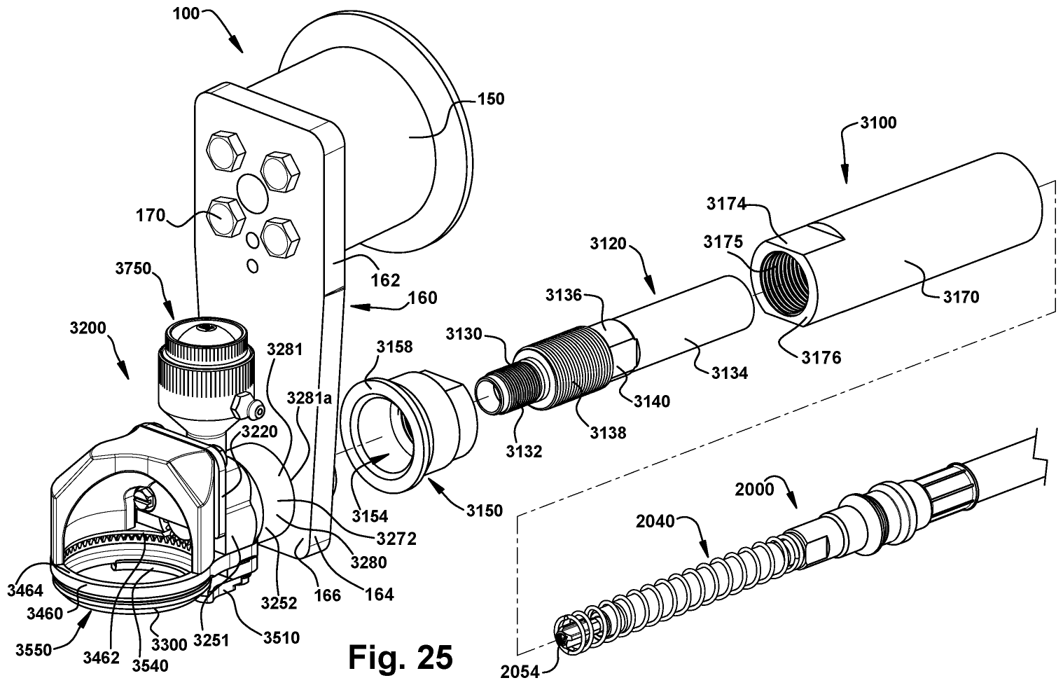

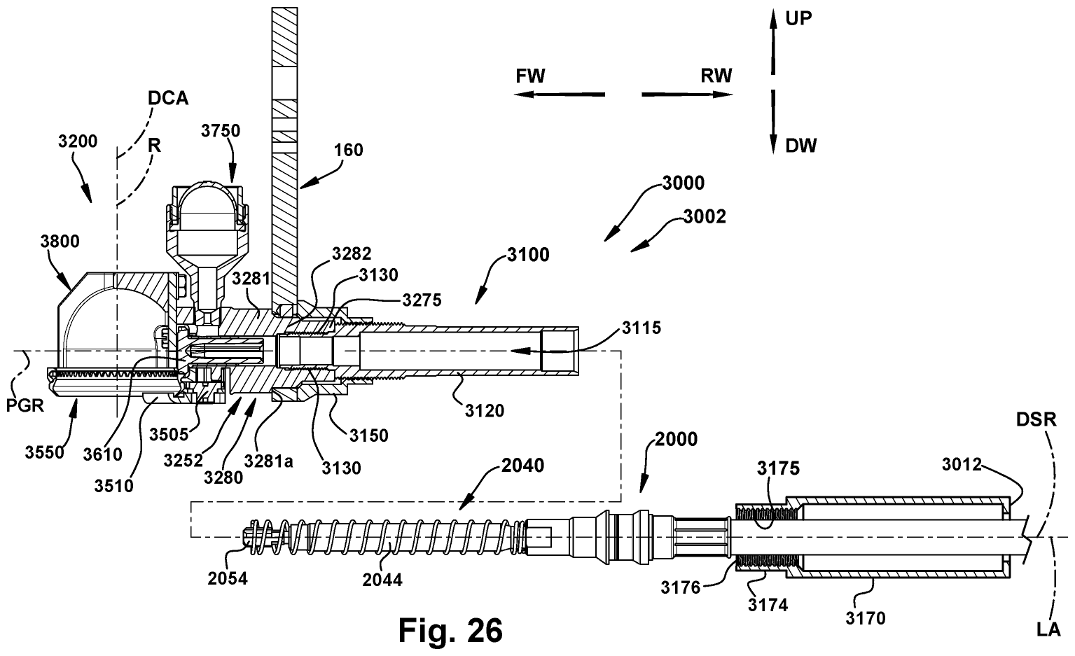

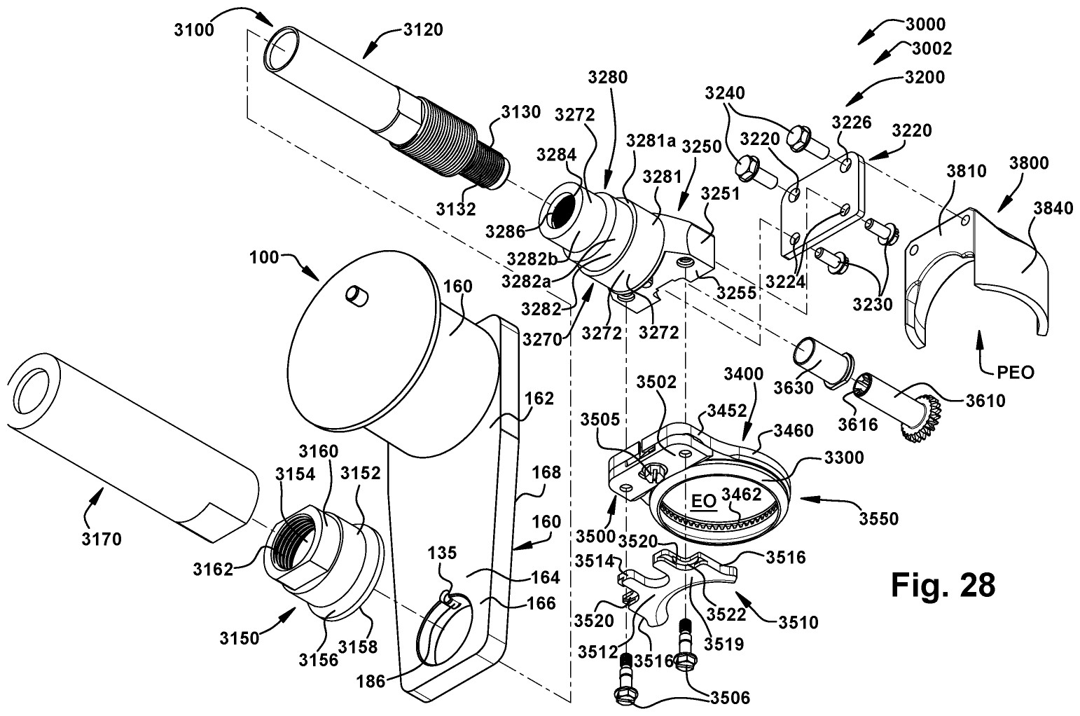

A second exemplary embodiment of a hand-held, power operated trimming tool 3000, such as a hand-held, power operated rotary knife 3002 depicted in FIGS. 22-28. Like the hand-held, power operated trimming tool 1000 of the first exemplary embodiment, the power operated trimming tool 3000 has been modified for mounting to an interface portion 264 of an end-of-arm tool connector 260 of a robotic arm 250 of a robotic arm assembly 200 thereby facilitating manipulation of the power operated trimming tool 3000 by the robotic arm assembly 200 for cutting and trimming purposes, as opposed to manual manipulation of the power operated trimming tool by a hand of a human operator. The power operated trimming tool 3000, in one exemplary embodiment, is the power operated rotary knife 3002, although it should be appreciated by those of skill in the art that the configuration of a handle assembly 3100 and the head assembly 3200 depicted herein are equally applicable to other power operated rotary trimming tools, such as, hand-held power operated skinning devices. For convenience, the following description will be directed to the depicted exemplary embodiment of the power operated rotary knife 3002, as representative of a class of hand-held, power operated trimming tools modified for mounting to an interface portion 264 of an end-of-arm tool connector 260 of a robotic arm assembly 200. Further, the configuration and function of the power operated rotary knife 3002 of the second exemplary embodiment is substantially similar to the configuration and function of the power operated rotary knife 1002 of the first exemplary embodiment. For brevity, the description of the power operated rotary knife 3002 of the second embodiment will generally focus on those components of the knife 3002 that are different from corresponding components of the power operated rotary knife 1002 of the first embodiment, it being understood that remaining description of the power operated rotary knife 1002 of the first exemplary embodiment is applicable to the power operated rotary knife 3002 of the second exemplary embodiment.

As schematically depicted in FIGS. 22-28, a second exemplary embodiment of a robotic arm assembly 100 includes an end-of-arm tool connector 160 which is operatively coupled to a robotic arm 150. The end-of-arm tool connector 160 includes an upper portion 162, which is affixed to the robotic arm 150 by a mechanical connection 170, and the lower or interface portion 164, which is affixed to the power operated rotary knife 3002. The lower interface portion 164 includes a front wall or front surface 166, facing in the forward or distal direction FW, and a back wall or back surface 168, facing in a rearward or proximal direction RW. The lower interface portion 164 includes an opening or through bore 180 defined by an inner surface 182. In the first exemplary embodiment of the end-of-arm tool connector 160, the inner surface 182 of the through bore 180 included three inwardly extending tabs 184 that fit into three corresponding longitudinally extending grooves 1283 of the outer surface 1272 of the cylindrical annular boss 1280 of the handle assembly interface portion 1270 of the rearward or proximal portion 1252 of the frame body 1250 of the head assembly 1200 of the power operated rotary knife 1002. In the second exemplary embodiment, the inner surface 182 of the through bore 180 of the lower interface portion 164 includes a cylindrical recess 185. A dowel pin 186 is press fit into the cylindrical recess 185. A radially inwardly extending portion 187 of the dowel pin 186 protrudes or extends into the cylindrical opening of the through bore 180.

Power Operated Rotary Knife 3000

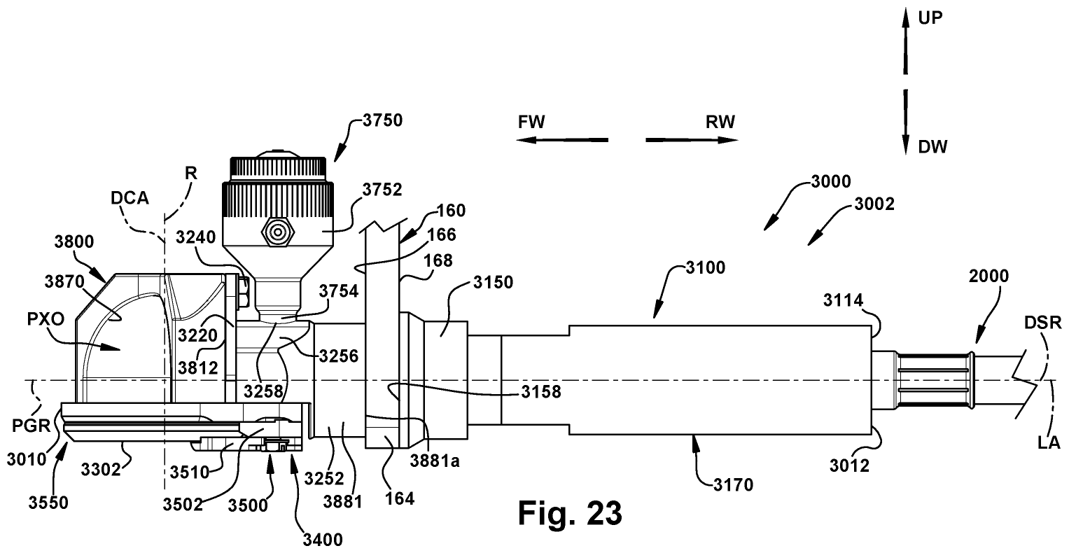

In a second example or exemplary embodiment of the power operated trimming tool 3000 of the present disclosure, the trimming tool 3000 is the power operated rotary knife 3002, as schematically depicted in FIGS. 22-28. The power operated rotary knife 3002 extends between a distal or working end 3010 of the knife 3002 and a proximal end 3012 and includes the head assembly 3200, defining the working end 3010 of the knife 3002, and an elongated handle assembly 3100 releasably attached to the head assembly 3200 and extending in a rearward or proximal direction RW (FIG. 23) from the head assembly 3200. The head assembly 3200 of the power operated rotary knife 3002 includes a frame body 3250 which includes a forward or distal portion 3251 and a rearward or proximal portion 3252 extending longitudinally in the rearward direction RW from the forward portion 3251 of the frame body 3250. The rearward or proximal portion 3252 of the frame body 3250 includes a handle assembly and end- of-arm tool connector interface portion 3270 that interfaces with or is coupled to both the handle assembly 3100 and the lower, interface portion 164 of the end-of-arm tool connector 160.

In one exemplary embodiment the interface portion 3270 of the proximal portion 3252 of the frame body 3250 includes a generally cylindrical or annular boss 3280 with an outer surface 3272 having multiple diameters. The radially inwardly extending portion 187 of the dowel pin 186 of the through bore 180 of the lower interface portion 164 of the end-of-arm tool connector 160 interfits into or is received in a corresponding longitudinally extending groove 3283 in the outer surface 3272 of a reduced diameter rearward section 3282 of the annular boss 3280. The fit of the radially inwardly extending portion 187 of the dowel pin 186 into the longitudinally extending groove 3283 prevents rotation of the power operated rotary knife 3002 within the through bore 182 of the end-of-arm tool connector 160.

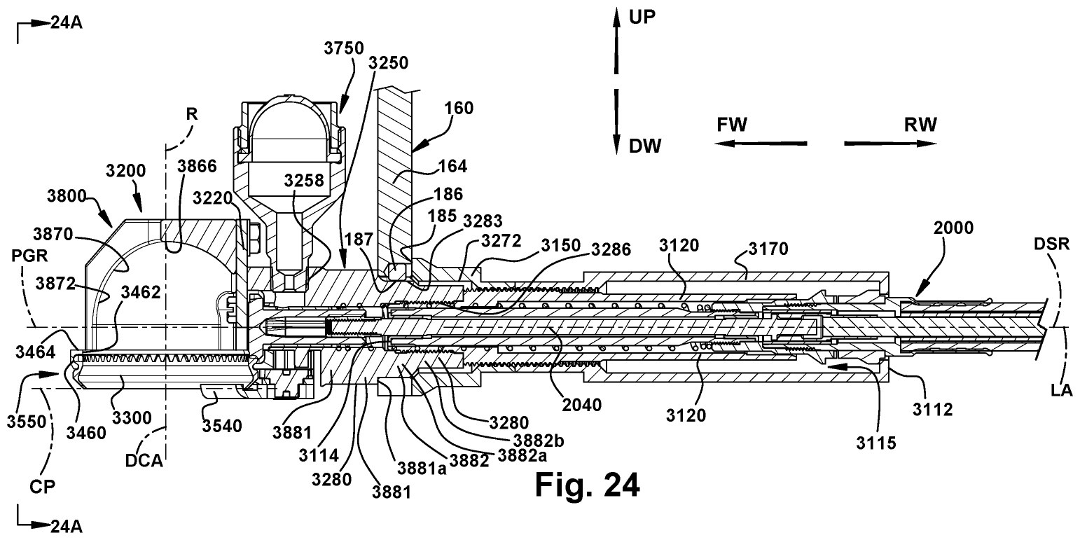

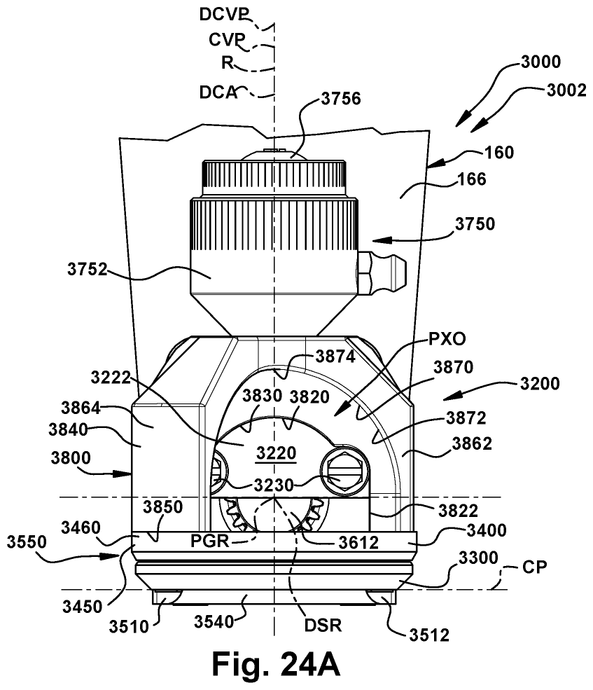

The annular boss 3282 of the interface portion 3270 of the proximal portion 3252 of the frame body 3250 includes an enlarged diameter forward section 3881 and the reduced diameter rearward section 3282 that includes the longitudinally extending groove 3283. The difference in the diameters of the outer surface 3272 of the enlarged diameter forward section 3881 and the reduced diameter rearward section 3282 results in a radially extending, annular step or shoulder 3881a at the interface of the two sections 3881, 3882 (as best seen in FIG. 24). This annular surface or shoulder 3881a provides an annular bearing surface between the frame body 3250 and the front wall 166 of the lower, interface portion 164 of the end-of-arm tool connector 160 in the region of or adjacent to the through bore 180 thereby advantageously providing for a 360 degree bearing region of contact between the shoulder 3881a of the annular boss 3280 of the frame body 3250 and the front wall 166 of the end-of-arm tool connector 160 in the region of the through bore 180.

The handle assembly 1100 is releasably attached to and extends along a handle assembly central or longitudinal axis LA. The handle assembly 1100 is releasably affixed to the handle assembly and end-of-arm tool connector interface portion 3270 of a rearward or proximal portion 3252 of the frame body 3250 of the head assembly 3200. The handle assembly 3100 extends between a distal end 3112 and a proximal end 3114, which also is the proximal end 3012 of the power operated rotary knife 3002. The handle assembly 3100 includes a central through bore 3115, which extends along and is centered about the handle assembly longitudinal axis LA. The handle assembly central through bore 3115 is sized to receive a distal driver assembly 2040 of a shaft drive transmission 2000 that provides rotational power to a drive mechanism 3600 of the power operated rotary knife 3002.

The handle assembly 1100 includes a connector engagement member or collar 3150 and a generally cylindrical central core 3120. The central core 3120 includes a first threaded outer surface section 3132 in a forward, reduced diameter interface portion 3130 and second threaded outer surface section 3138 in a central portion 3136 of the central core 3150, the first threaded outer surface section 3132 being of smaller diameter than the second threaded outer surface section 3138. The connector engagement member or collar 3150 includes an annular body 3152 having an enlarged diameter distal portion 3156 and a reduced diameter proximal portion 3160. The enlarged diameter distal portion 3156 of the connector member 3150 includes a planar, annular distal or forward wall 3158. An inner surface 3155 of the annular body 3152 of the connector member 3150 in the region of the proximal portion 3160 includes a threaded inner surface or section 3162 which is sized to be received on and engage the second threaded outer surface section 3138 of the central portion 3136 of the central core 3150. The first threaded outer surface section 3132 of the forward, reduced diameter interface portion 3130 of the central core 3120 threads into a threaded interior surface section 3286 of an inner surface 3284 of the annular boss 3280 of the interface portion 3270 of the proximal portion 3252 of the frame body 3250 to secure the handle assembly 3100 to the frame body 3250.

Additionally and advantageously, the connector member 3150 is also threaded onto the second threaded outer surface section 3138 of the central portion 3136 of the central core 3150. Accordingly, as the central core 3120 is rotated to thread or tighten into the threaded interior surface section 3286 of the inner surface 3284 of the annular boss 3280 of the frame body 3250 to affix the handle assembly 3100 to the frame body 3250 of the head assembly 3100, the annular distal or forward wall 3158 of the enlarged diameter distal portion 3156 of the connector member 3150 is urged against the back wall 168 of the lower interface portion 164 of the end-of-arm tool connector 160 in the region of or adjacent to the through bore 180 thereby advantageously providing for a 360 degree bearing region of contact between the annular forward wall 3158 of the connector member 3150 and the back wall 168 of the end-of-arm tool connector 160 in the region of the through bore 180. This results in the lower interface portion 164 of the end-of-arm tool connector 160 in the region of or adjacent to the through bore 180 being sandwiched between two directly opposed annular bearing regions of contact, one bearing region of contact between the shoulder 3881a of the annular boss 3280 of the frame body 3250 and the front wall 166 of the end-of-arm tool connector 160 in the region of the through bore 180 and the second bearing region of contact between the annular distal or forward wall 3158 of the enlarged diameter distal portion 3156 of the connector member 3150 and the back wall 168 of the end-of-arm tool connector 160 in the region of the through bore 180. This configuration advantageously and simultaneously provides for both positive securement between the handle assembly 3100 and the frame body 3250 and between the power operated rotary knife 3002 and the end-of-arm tool connector 160.

The power operated rotary knife 1002 extends between a distal or working end 3010 of the knife 3002 and a proximal end 3012 and includes the head assembly 3200 and the elongated handle assembly 3100. The handle assembly 1100 is releasably attached to and extends along a handle assembly central or longitudinal axis LA from the handle assembly interface portion 3270 of the rearward or proximal portion 3252 of the frame body 3250 of the head assembly 3200. The handle assembly 3100 extends between a distal end 3112 and a proximal end 3114, which also is the proximal end 3012 of the power operated rotary knife 3002. The handle assembly 3100 includes a central through bore 3115, which extends along and is centered about the handle assembly longitudinal axis LA. The handle assembly central through bore 3115 is sized to receive a distal driver assembly 2040 of a shaft drive transmission 2000 that provides rotational power to a drive mechanism 3600 of the power operated rotary knife 3002. The drive mechanism 3660, in turn, drives an annular rotary knife blade 3300 about a blade central axis of rotation R.

Head Assembly 3200

In one exemplary embodiment and as best seen in FIGS. 22-28, the head assembly 3200 includes the frame body 3250, a blade housing assembly 3400, the annular rotary knife blade 3300, and the drive mechanism 3600 for rotating the annular rotary knife blade 3300. In addition to supporting the handle assembly 3100, the frame body 3250 also supports the blade housing assembly 3400 which, in turn, supports the annular rotary knife blade 3300 for rotation about the central axis of rotation R. The blade housing assembly 3400 includes a split blade housing 3450 and a cam mechanism 3500 coupled to a mounting section 3452 of the split blade housing 3450. A blade supporting section 3460 of the split blade housing 3450 extends from the mounting section 3450 and supports the annular rotary knife blade 3300 for rotation about the central axis of rotation R. The cam mechanism 3500 is operable to change the split blade housing 3450 and, specifically, the blade supporting section 3460 of the split blade housing 3450 between a blade supporting position and an enlarged diameter blade changing position wherein the rotary knife blade 3300 may be removed from the split blade housing 3450. Additional details of the blade housing assembly 3400, including the split blade housing 3450 and the cam mechanism, are disclosed in aforementioned U.S. Pat. No. 10,471,614 to Whited et al., which is assigned to the assignee of the present application and which is incorporated by reference herein in its entirety.

The lower cutting edge 3302 of the annular rotary knife blade 3300 defines a cutting plane CP of the power operated rotary knife 3002. The cutting plane CP is orthogonal to the blade axis of rotation R and parallel to and disposed below (that is, in the downward direction DW from) the handle assembly longitudinal axis LA. An assembled combination of the annular rotary knife blade 3300, as rotatably supported by a split blade housing 3450 of the blade housing assembly 3400, is referred to as an assembled blade-blade housing combination 3550. The drive mechanism 3600 is at least partially supported by and disposed within the frame body 3250. The drive mechanism 3600 is operatively coupled to and rotates the annular rotary knife blade 3300 about the blade axis of rotation R. The directions up UP and down DW, as used herein are parallel to a direction of the blade axis of rotation R.

The frame body 3250 includes a central through bore or opening 3290 centered about and extending along the handle assembly longitudinal axis LA and further includes the enlarged forward or distal portion 3251 and the generally cylindrical rearward or proximal portion 3252 extending from the enlarged forward portion 3251. The forward portion 3251 of the frame body 3250 includes a lower planar surface 3255 which serves as a mounting pedestal for the blade housing assembly 3400. The forward portion 3251 of the frame body 3250 also include an upper surface 3256 which receives a stationary lubrication assembly 3750. The upper surface 3256 includes a threaded port 3258 which receives a corresponding threaded fitting 3754 of a lubrication reservoir 3752 of the lubrication assembly 3750. The lubrication reservoir 3750 includes a supply of edible lubricant. When a bladder 3756 affixed to an upper end of the lubrication reservoir 3752 is depressed, edible lubricant from the lubrication reservoir 3752 is channeled from the reservoir 3752 through the fitting 3752 and the port 3258 into the central through bore or opening 3290 of the frame body 3250 where the lubricant is applied to a drive gear, such as a pinion gear 3610, of the drive mechanism 3600. The annular body 1702 of the rotatable lubrication assembly 1700 of the power operated rotary knife 1002 of the first exemplary embodiment is replaced by a spacer ring 3750 of appropriate size, which is received on a forward section 3281 of the annular boss 3280 of the rearward portion 3252 of the frame body 3250.

The rearward portion 3252 of the frame body 3250 includes the handle assembly and end-of-arm tool connector interface portion 3270 which is coupled to and/or supports: a) the threaded portion 3132 of the forward, reduced diameter interface portion 3130 of the central core 3120 of the handle assembly 3100 to affix the handle assembly 3100 to the head assembly 3200; and b) the interface portion 164 of the end-of-arm tool connector 160 of the robotic arm assembly 100. The rearward or proximal section 3282 of the annular boss 3280 of the rearward portion 3252 of the frame body 3250 includes the longitudinally extending groove 3283 formed in the outer surface 3272 of the annular boss 3280 of the handle assembly interface portion 3270 that receive the protruding portion 187 of the dowel pin 186 of the inner surface 182 of the through bore 180 of the end-of-arm tool connector lower portion 164 to facilitate mounting or coupling of the power operated rotary knife 3002 to the end-of-arm tool connector 160. The rearward section 3282 of the annular boss 3280 also includes the threaded proximal section or portion 3286 of the inner surface 3284 of the annular boss 3280 defining a portion of the central opening 3290 of the frame body 3250. The threaded inner surface portion 3286 of the annular boss 3280 receives and engages the mating threaded outer surface 3132 of the forward or distal, reduced diameter, frame body interface portion 3130 of the central core 3120 of the handle assembly 3100 to attach the handle assembly 3100 to the handle assembly interface portion 3270 of the head assembly 3200.

The rearward or proximal section 3282 of the annular boss 3280 of the rearward portion 3252 of the frame body 3250 includes two parts: a) a forward part 3282a that includes the groove 3283; and b) a proximal part of reduced diameter rearward section 3282, the proximal part having a reduced diameter with respect to the forward part 3282a. As previously discussed , the mounting of the power operated rotary knife 3002 is advantageously secured by both longitudinal and radial engagement between the power operated rotary knife 3002 and the lower interface portion 164 of the end-of-arm connector 160. Specifically, securement between the power operated rotary knife 3002 and the lower interface portion 164 of the end-of-arm connector 160 is accomplished by the following: a) abutting contact or engagement between the shoulder 3881a of the annular boss 3280 of the frame body 3250 and the front wall 166 of the end-of-arm tool connector 160 adjacent the through bore 180 of the connector 160; b) abutting contact or engagement between the annular distal or forward wall 3158 of the enlarged diameter distal portion 3156 of the connector member 3150 and the back wall 168 of the end-of-arm tool connector 160 adjacent the through bore 180 of the connector 160; and c) abutting contact or engagement between the radially inwardly protruding portion 187 of the dowel pin 186 of the inner surface 182 defining the connector through bore 180 and the longitudinally extending groove 3283 of the rearward section 3282 of the annular boss 3280 of the interface portion 3270 of the frame body 3250. Parts (a) and (b) noted above constitute engagement or contact along the handle assembly longitudinal axis LA and part (c) note above constitutes radial engagement or contact with respect to the handle assembly longitudinal axis LA that inhibits rotation of the power operated rotary knife 3002 about the longitudinal axis LA within the through bore 180 of the end-of-arm tool connector 160.

The forward or distal portion 3251 of the frame body 3250 supports the drive mechanism 3600, which, in one exemplary embodiment, includes the drive gear 3610, such as the pinion gear. The pinion gear 3610 includes a gear head 3612 that engages a set of gear teeth of the annular rotary knife blade 3300 to rotate the rotary knife blade 3300 about the blade central axis of rotation R. Extending in the rearward direction RW from the gear head 3612 of the pinion gear 3610 is a hollow shaft 3614 that defines a socket-like driven fitting 3616. The driven fitting 3616 defined by the shaft 3614 of the pinion gear 3610 receives a drive fitting 2054 of the driver assembly 2040 of the shaft drive transmission 2000. The pinion gear 3610 is supported for rotation about a pinion gear axis of rotation PGR by a sleeve bushing 3630 supported by the through bore 3290 of the frame body 1250. The drive fitting 2054 is coupled to a distal end of a driver shaft 2050 of the driver assembly 2040. As the driver shaft 2050 is driven for rotation about the drive shaft axis of rotation DSR, the drive fitting 2054 of the driver shaft 2050 engages driven fitting 3616 of the pinion gear 1610 and rotates the pinion gear 1610 about the pinion gear axis of rotation PGR. In one exemplary embodiment, the pinion gear axis of rotation PGR, the drive gear axis of rotation DSR and the handle assembly central longitudinal axis LA are aligned or coincident.

The head assembly 3200 further includes a mounting plate 3210 and a product diverter 3800, which overlies a product exit opening EO of the assembled blade-blade housing combination 3550, and is configured, under certain cutting conditions and angles, to divert trimmed product, such as trimmed meat pieces, away from the product exit opening EO of the assembled blade-blade housing combination 3550 so that the trimmed product falls away from the power operated rotary knife 3002 and onto a finished product conveyor. The product exit opening EO of the assembled blade-blade housing combination 3550 is defined by an inner wall 3462 and an upper wall 3464 of a blade supporting section 3460 of the split blade housing 3450 of the blade housing assembly 3400. The product diverter 3800 mounts to the mounting plate 3220 and, in turn, the mounting plate 3220 mounts to a planar distal wall or surface 3251a of the forward portion 3251 of the frame body 3250 thereby forming a forward facing wall of the forward portion 3251 of the frame body 3250 adjacent the pinion gear gear head 3612. The mounting plate 3220 is secured to the distal wall 3251a of the forward portion 3251 of the frame body 3250 by a pair of threaded fasteners 3230 which pass through a pair of countersunk holes 3224 of the mounting plate 3220 and thread into threaded openings 3251b of the distal wall 3251a of the forward portion 3251 of the frame body 3250. The pair of holes 3224 of the mounting plate 3220 are countersunk on a front wall 3222 of the mounting plate 3220 so that heads of the pair of fasteners 3230 are level with the front wall 3222. The product diverter 3800 is secured to the front wall 3222 of the mounting plate 3220 by a second pair of threaded fasteners 3240 that pass through a pair of apertures 3226 of the mounting plate 3220 and thread into threaded openings 3814 in a planar wall 3812 of an attachment section 3810 of the product diverter 3800.

The product diverter 3800 is an optional piece of the head assembly 3200 of the power operated rotary knife 3002 of the second example embodiment that may be utilized in certain trimming and cutting applications wherein the power operated rotary knife 3002 is manipulated by the robotic arm 150. For example, in one robotic work station application, the robotic arm 150 manipulates the rotary knife 3002 to cut in a vertically downward direction with respect to a chicken carcass on a conveyor line that is stopped at the work station. For trimming of chicken tenders or hanging tenders from each side of the breast of a chicken carcass, the blade moves in a downward direction and a distal portion of the blade engages the carcass, the knife 3002 being angled upwardly, that is, the handle assembly 3100 being axially lower than the rotary knife blade 3300. It is desired to direct the trimmed tender away from a product exit opening EO defined by the inner and upper walls 3462, 3464 of a blade supporting section 3460 of the split blade housing 3450 of the blade housing assembly 3400 so that the trimmed tender is directed away from the product exit opening EO of the split blade housing the cutting opening CO and falls away laterally through a product exit opening PXO of the product diverter 3800 onto, for example, a trimmed product conveyor line that is axially below and laterally displaced from the conveyor line used for moving the chicken carcasses between robotic work stations.

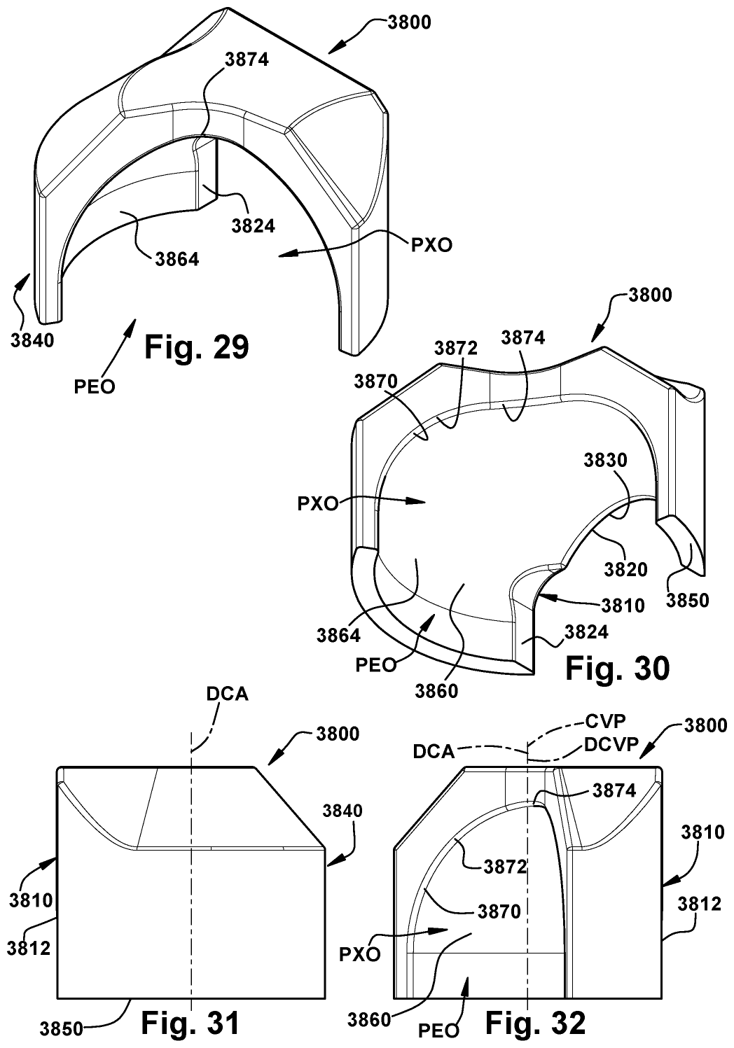

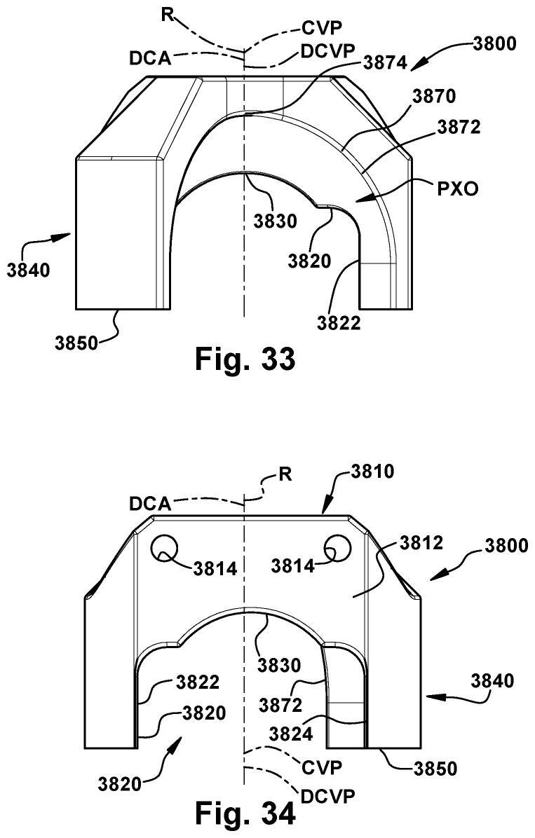

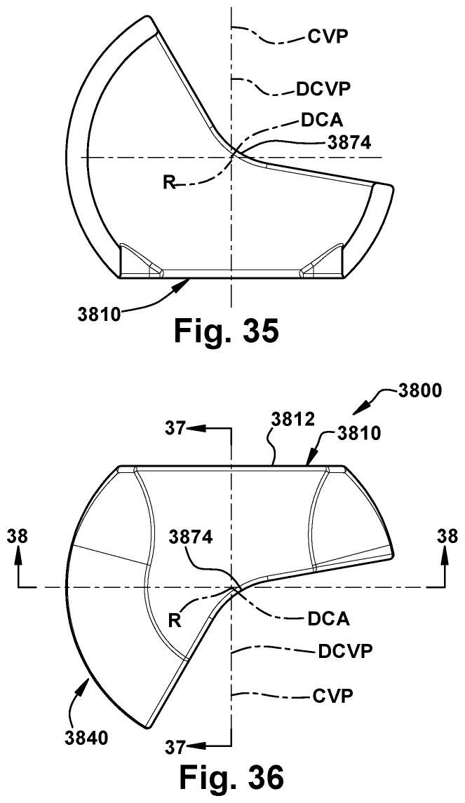

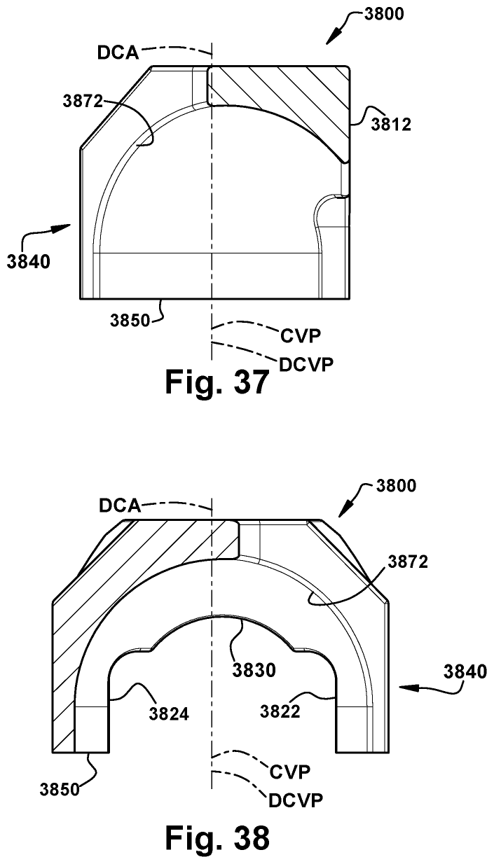

In one exemplary embodiment, as best seen in FIGS. 29-38, the product diverter 3800 includes an attachment section 3810 for mounting to the mounting plate 3220 and a generally dome-shaped product diverter or diverter section 3840 extending from the attachment section 3810. The diverter section 3840 of the product diverter 3800 functions to divert or direct a path of travel of trimmed meat product from a product entrance opening PEO of the product diverter 3800 that is contiguous or overlies the product exit opening EO of the assembled blade-blade housing combination 3550 in a lateral direction to a product exit opening PXO of the product diverter 3800. The attachment section 3810 of the product diverter includes the generally planar wall 3812 suitable for attachment to the front wall 3222 of the mounting plate 3220 by the second pair of threaded fasteners 3240. The front wall 3222 is generally parallel to a central vertical axis DCA of the product diverter 3800 and is orthogonal to a central vertical plane DCVP of the product diverter 3800. The product diverter central vertical plane DVCP is coincident with the central vertical plane CVP of the power operated rotary knife 3002. The attachment section 3810 of the product diverter 3800 further include a clearance cut-out 3820 that provides clearance in the region of the pinion gear gear head 3612. The clearance cut-out 3820 is defined by left and right vertical side walls 3822, 3824 bridged by an upper wall 3830 of the clearance cut-out 3820.

The diverter section 3840 of the product diverter 3800 includes an interrupted circumferential base 3850 and an inner wall 3860 which converges from the circumferential base 3850 toward an inner wall vertex 3866 which, in one exemplary embodiment, lies on the central vertical axis DCA of the product diverter 3800. The circumferential base 3850 is circular in plan view and is interrupted by the clearance cut-out 3820 of the attachment section 3810 and the product exit opening PXO of the product diverter 3800. The product entrance opening PEO is defined by the circumferential base 3850 of the diverter section 3840, while the product exit opening PXO of the product diverter 3800 is defined by a product exit cut-out 3870 in a side wall 3872 of the diverter section 3840. The inner wall 3860 of the diverter section 3840 includes a first arcuate portion 3862 extending between the left vertical side wall 3822 of the clearance cut-out 3820 and the product exit cut-out 3870 and a second arcuate portion 3864 extending between the right vertical side wall 3824 of the clearance cut-out 3820 and the product exit cut-out 3870. The side wall 3872 defining the product exit cut-out 3870 is arcuate proceeding toward a side wall vertex 3874. The trimmed meat product travels along the second arcuate portion 3864 of an inner surface 3860 of the diverter section 3840 is a direction toward the inner wall vertex 3866. Given that the trimmed meat product is flaccid or flexible and given the position of the product exit opening PXO and the position and configuration of the second arcuate portion 3864, the trimmed meat product travels along the second arcuate portion 3864 in a direction toward the inner wall vertex 3866. Given the curvature and extent of the second arcuate portion 3864, the trimmed meat product is directed toward and falls though the product exit opening PXO, which moves the trimmed meat product laterally away from the central vertical plane DCVP of the product diverter so that the trimmed meat product fall away from the carcass and onto a finished product conveyor. As best seen in the front elevation view of FIG. 24A, the second arcuate portion 3864 of the diverter section 3840 of the product diverter 3800 extends arcuately and forwardly from the right side wall 3824 of the clearance cut-out 3820 toward the product exit cut-out 3870 such that a forward part of the second arcuate portion 3864, in front elevation view and as mounted to the head assembly 3200, overlies a portion of the clearance cut-out 3820 of the attachment section 3810 of the product diverter 3800, including the right side wall 3824 of the clearance cut-out 3820. In front elevation view, as seen in FIG. 24A, the product exit opening PXO of the product diverter 3800m, as defined by the product exit cut-out 3870, extends laterally on either side of the central vertical plane DCVP of the product diverter 3800 and the coincident central vertical plane CVP of the power operated rotary knife 3002. That is, the product diverter central vertical plane DCVP (and the power operated rotary knife central vertical plane CVP) extends or cuts through the product exit opening PXO.

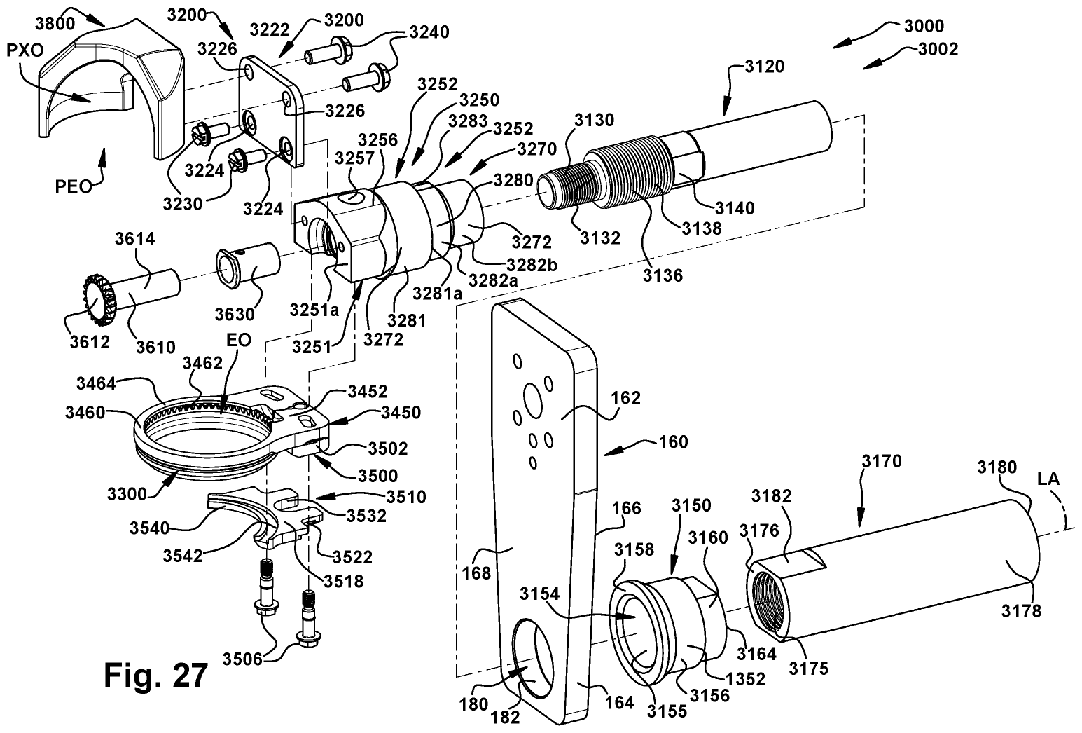

Another optional component of the head assembly 3200 of the power operated rotary knife 3002 is the blade guard 3510, best seen in FIGS. 27 & 28. Like the product diverter 3800, the blade guard 3200 may be advantageously employed under certain cutting conditions, specifically cutting conditions were the power operated rotary knife 3002 is manipulated by the robotic arm 150 to trim a meat product to obtain thin slices of trimmed meat product. In such instances, when a hook-style rotary knife blade, like the rotary knife blade 3300, is utilized the angle of the cutting plane CP with respect to horizontal is extremely shallow. If a front portion of the rotary knife blade 3300 is used for cutting, for example, as explained above, chicken tenders, there is a possibility that the opposite side of the cutting edge 3302 of the blade 3300 in the vicinity of the pinion gear gear head 3612 may undesirably scape against or abrade the upper surface of the meat product. The blade guard 3200 advantageously overlies cutting edge 3302 of the rotary knife blade 3300 in the region of the pinion gear gear head 3612.

In one exemplary embodiment, the blade guard 3510 includes a base 3512 having a pair of side walls 3516 space apart by a back wall 3514. The base 3512 also includes an upper wall 3518 and an axially space apart lower wall 3819. The back wall 3514 of the base 3512 includes a pair of fastener recesses 3520 and a central cam actuator recess 3532 in the back wall 3532 to provide clearance for actuating the cam actuator 3505 of the cam mechanism 3500. The pair of back wall fastener recesses 3520 each includes extending shoulder portions 3522 that provide a seating surface for enlarged heads of a pair of fasteners 3506 that secure the cam plate 3502 of the cam mechanism 3500 and the blade guard 3510 to the lower planar surface 3255 of the forward portion 3251 of frame body 3250 that serves as a mounting pedestal for the blade housing assembly 3400. In one exemplary embodiment, the blade guard 3510 is a separate component from the stationary cam plate 3502 to which it is mounted by the pair of fasteners 3506. It should be appreciated that in an alternate exemplary embodiment, the blade guard base 3512 could be fabricated to be integral with the cam plate 3502 thereby eliminating the need for the back wall fastener recesses 3250, the cam plate 3502 and the blade guard 3510 being fabricated as a single component.

The blade guard 3510 further includes an arcuate blade guard section 3540 extending forwardly from the base 3512. An upper wall or surface of the blade guard section 3540 includes an arcuate groove 3542 that receives (but is spaced from) a lower region of the rotary knife blade 3300, including the cutting edge 3302. The blade guard section 3450 advantageously protects the blade cutting edge 3302 in the region of the pinion gear gear head 3610 from contacting or abrading the upper surface of the meat work piece or carcass when the rotary knife 3303 is manipulated by the robotic arm 150 to take thin cuts of meat at a shallow angle of cut or angle of attack with respect to the meat work piece.

Handle Assembly 3100

The handle assembly 3100 includes the generally cylindrical central core 3120 overlied by the generally cylindrical connector engagement member or connector engagement collar 3150 and the generally cylindrical driver assembly retainer member or collar 3170. The connector engagement member 3150 and the driver assembly retainer member 3170, in one exemplary embodiment, threadedly engage a threaded outer surface 3138 of a central portion 3136 of the central core 3120 to affix the connector engagement member 3150 and the driver assembly retainer member 3170 to the central core 3120. The central core 3120, in turn, includes the threaded outer surface 3132 in the forward, reduced diameter, frame body interface portion 3130 of the central core 3120. In one exemplary embodiment, the threaded outer surface 3132 of the forward, reduced diameter, frame body interface portion 3130 threadedly engages a threaded proximal portion 3286 of the inner surface 3284 of the cylindrical annular boss 3280 of the frame body 3250 to secure the central core 3120, and, therefore, the handle assembly 3100 to the frame body 3250.

The threaded outer surface 3138 of the central portion 3136 of the central core 3120 functions to facilitate securement of both the connector engagement member 3150 of the handle assembly 3100 and the driver assembly retainer member 3170 of the handle assembly 3100 to the central core 3120. Specifically, the connector engagement member 3150 includes a threaded inner surface 3162 of a central opening or through bore 3154 which threadedly engages the threaded outer surface 3138 of the central portion 3136 of the central core 3120 to secure the connector engagement member 3150 to the central core 3120. Similarly, the driver assembly retainer member 3170 includes a threaded inner surface 3175 of a distal portion 3174 of the member 3170 which threadedly engages the threaded outer surface 3138 of the central portion 3136 to secure the driver assembly retainer member 3170 to the central core 3120. In one exemplary embodiment, a forward wall 3176 of the driver assembly retainer member 3170 contacts or engages a back wall 3164 of a reduced diameter proximal portion 3160 of the connector engagement member 3150 to limit the extend of forward travel of the driver assembly retainer member 3170 with respect to the central core 3120. A non-threaded portion of the outer surface of the central portion 3136 includes opposing flats 3140 to allow for tightening the central core 3120 into the frame body annular boss 3280 using a conventional end wrench.

The connector engagement member or collar 3150 abuts the back wall 168 of the lower interface portion 164 of the end-of-arm tool connector 160 in the region of the through bore 180 of the connector 160 and thus advantageously functions as part of the securement structure that secures the power operated rotary knife 3002 to the end-of arm tool connector 160. In one exemplary embodiment, the connector engagement member 3150 comprises the stepped annular body 3152 that extends between the forward wall or end 3158 and the back wall or end 3164. As the connector engagement member 3150 overlies and is threadedly coupled to the central core 3120, both the inner and outer diameters of the connector engagement member 3150 are necessarily greater than the corresponding inner and outer diameters of the central core 3120. The annular body 3152 of the connector engagement member 3150 includes the central opening or through bore 3154 defined by an inner surface 3155. The through bore 3154 extends along and is centered about the handle assembly longitudinal axis LA.

The connector engagement member 3150 is stepped in that the annular body 3152 includes an enlarged diameter distal portion 3156 and the reduced diameter proximal portion 3160. The forward wall 3158 of the enlarged diameter distal portion 3156 of the connector engagement member 3150 engages the back wall 168 of the lower interface portion 164 of the end-of-arm connector 160. Advantageously, the enlarged diameter distal portion 3156 defines a similarly enlarged section of the through bore 3154 that is sufficiently large in diameter to: a) provide for clearance with respect to the outer diameter of the rearward section 3282 of the cylindrical annular boss 1280 of the frame body 1250; and b) provide for a 360 degree annulus or annular region of contact between the forward wall 3158 of the enlarged diameter distal portion 3156 of the connector engagement member 3150 and the back wall 168 of the lower interface portion 164 of the end-of-arm connector 160, that is, a circular ring of contact between the respective forward and back walls 3158, 168 of the connector engagement member 3150 and the end-of-arm tool connector 160 that is radially outward of the through bore 180 of the end-of-arm tool connector 160.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present disclosure/invention. It is, of course, not possible to describe every conceivable combination of components, assemblies, or methodologies for purposes of describing the present disclosure/invention, but one of ordinary skill in the art will recognize that many further combinations and permutations of the present disclosure/invention are possible. Accordingly, the present disclosure/invention is intended to embrace all such alterations, modifications, and variations that fall within the spirit and scope of the appended claims.

What is claimed is:

1. A handle assembly for a power operated trimming tool configured to be coupled to an interface portion of an end-of-arm tool connector of a robotic arm, the power operated trimming tool including a head assembly supporting a drive mechanism of the power operated trimming tool and the handle assembly extending from a proximal interface portion of a frame body of the head assembly, the handle assembly including a through bore extending along a handle assembly longitudinal axis, the through bore configured for receiving a driver assembly of a shaft drive transmission, the driver assembly operatively coupled to the drive mechanism of the power operated trimming tool, the handle assembly comprising:
a) a central core extending along the handle assembly longitudinal axis and including a central through bore defining a portion of the handle assembly through bore, the central core including a first distal interface portion and a threaded exterior section, the first distal interface portion configured to engage a proximal interface portion of a frame body to attach the handle assembly to a frame body;
b) a connector engagement member having a central opening extending along the handle assembly longitudinal axis and including a first distal portion and a second proximal portion, the second proximal portion of the connector engagement member including a threaded interior section engaging the threaded exterior section of the central core to attach the connector engagement member to the central core, the first distal portion of the connector engagement member including a front wall configured to contact an interface portion of an end-of-arm tool connector of a robotic arm; and
c) a driver assembly retainer member having a central opening extending along the handle assembly longitudinal axis, the driver retainer member securing a driver assembly of a shaft drive transmission within the through bore of the handle assembly and including a first distal portion and a second proximal portion, the first distal portion of the driver assembly retainer member including a threaded interior section engaging the threaded exterior section of the central core to attach the driver assembly retainer member to the central core.

2. The handle assembly of claim 1 wherein the central core includes the first distal interface portion, a second central portion and a third proximal portions spaced from the first distal interface portion, the second central portion including the threaded exterior section.

3. The handle assembly of claim 1 wherein the first distal interface portion of the central core includes a threaded exterior section configured to engage a threaded section of a proximal interface portion of a frame body of a head assembly of the power operated trimming tool.

4. The handle assembly of claim 1 wherein the second proximal portion of the driver assembly retainer member includes a back wall configured to engage a driver assembly of a shaft drive transmission to secure a driver assembly of a shaft drive transmission within the through bore of the handle assembly.

5. The handle assembly of claim 1 wherein the second proximal portion of the connector engagement member includes a back wall and the first distal portion of the driver assembly retainer member includes a front wall, the back wall of the connector engagement member contacting the front wall of the driver assembly retainer member.

6. The handle assembly of claim 1 wherein the central opening of the driver assembly retainer member defines a portion of the handle assembly through bore.

7. The handle assembly of claim 1 wherein the front wall of the first distal portion of the connector engagement member is planar.

8. A power operated trimming tool configured to be coupled to an interface portion of an end-of-arm tool connector of a robotic arm, the power operated trimming tool comprising:
a) a head assembly including a frame body and a drive mechanism of the power operated trimming tool, the frame body supporting at least a portion of the drive mechanism and including a front portion and a proximal interface portion, the frame body proximal interface portion configured for coupling to an interface portion of an end-of-arm tool connector of a robotic arm; and
b) a handle assembly extending from the proximal interface portion of the frame body of the head assembly, the handle assembly including a through bore extending along a handle assembly longitudinal axis, the handle assembly through bore configured for receiving a driver assembly of a shaft drive transmission which is operatively coupled to the drive mechanism of the power operated trimming tool, the handle assembly includes:
i) a central core extending along the handle assembly longitudinal axis and including a central through bore defining a portion of the handle assembly through bore, the central core including a first distal interface portion and a threaded exterior section, the first distal interface portion engaging the frame body proximal interface portion to attach the handle assembly to the frame body; and
ii) a connector engagement member having a central opening extending along the handle assembly longitudinal axis and including a first distal portion and a second proximal portion, the second proximal portion of the connector engagement member including a threaded interior section engaging the threaded exterior section of the central core to attach the connector engagement member to the central core, the first distal portion of the connector engagement member including a front wall configured to contact an interface portion of an end-of-arm tool connector of a robotic arm.

9. The power operated trimming tool of claim 8 wherein the central core includes the first distal interface portion, a second central portion and a third proximal portions spaced from the first distal interface portion, the second central portion including the threaded exterior section.

10. The power operated trimming tool of claim 8 wherein the handle assembly further includes a driver assembly retainer member having a central opening extending along the handle assembly longitudinal axis, the driver retainer member including a first distal portion and a second proximal portion, the first distal portion of the driver assembly retainer member including a threaded interior section engaging the threaded exterior section of the central core to attach the driver assembly retainer member to the central core, the second proximal portion including a back wall configured to engage a driver assembly of a shaft drive transmission to secure a driver assembly within the through bore of the handle assembly.

11. The power operated trimming tool of claim 8 wherein the power operated trimming tool comprises a power operated rotary knife and the head assembly of the power operated trimming tool additionally includes a blade housing assembly secured to the front portion of the frame body and an annular rotary knife blade supported for rotation about a blade central axis of rotation by the blade housing assembly and the drive mechanism includes a pinion gear operatively coupled to the annular rotary knife blade to rotate the annular rotary knife blade about the blade central axis of rotation.

12. The power operated trimming tool of claim 8 wherein the first distal interface portion of the central core of the handle assembly includes a threaded exterior section and the proximal interface portion of the frame body of the head assembly includes a threaded interior section, the threaded exterior section of the central core of the handle assembly engaging the threaded interior section of the proximal interface portion of the frame body of the head assembly to attach the handle assembly to the frame body.

13. The power operated trimming tool of claim 10 wherein the second proximal portion of the connector engagement member of the handle assembly includes a back wall and the first distal portion of the driver assembly retainer member of the handle assembly includes a front wall, the back wall of the connector engagement member contacting the front wall of the driver assembly retainer member.

14. The power operated trimming tool of claim 8 wherein the proximal interface portion of the frame body includes an annular boss, an outer surface of the annular boss including a radially extending shoulder disposed between an enlarged diameter forward section and a reduced diameter rearward section of the annular boss, the radially extending shoulder configured to contact an interface portion of an end-of-arm tool connector of a robotic arm.

15. A power operated rotary knife configured to be coupled to an interface portion of an end-of-arm tool connector of a robotic arm, the power operated rotary knife comprising:
a) a head assembly including a frame body and a drive mechanism of the power operated trimming tool, the frame body supporting at least a portion of the drive mechanism and including a front portion and a proximal interface portion, the frame body proximal interface portion configured for coupling to an interface portion of an end-of-arm tool connector of a robotic arm; and
b) a handle assembly extending from the proximal interface portion of the frame body of the head assembly, the handle assembly including a through bore extending along a handle assembly longitudinal axis, the handle assembly through bore configured for receiving a driver assembly of a shaft drive transmission which is operatively coupled to the drive mechanism of the power operated trimming tool, the handle assembly includes:
i) a central core extending along the handle assembly longitudinal axis and including a central through bore defining a portion of the handle assembly through bore, the central core including a first distal interface portion and a threaded exterior section, the first distal interface portion engaging the frame body proximal interface portion to attach the handle assembly to the frame body; and
ii) a driver assembly retainer member having a central opening extending along the handle assembly longitudinal axis, the driver retainer member including a first distal portion and a second proximal portion, the first distal portion of the driver assembly retainer member including a threaded interior section engaging the threaded exterior section of the central core to attach the driver assembly retainer member to the central core, the second proximal portion including a back wall configured to engage a driver assembly of a shaft drive transmission to secure a driver assembly within the through bore of the handle assembly.

16. The power operated rotary knife of claim 15 wherein the central core includes the first distal interface portion, a second central portion and a third proximal portions spaced from the first distal interface portion, the second central portion including the threaded exterior section.

17. The power operated rotary knife of claim 15 wherein the handle assembly further includes a connector engagement member having a central opening extending along the handle assembly longitudinal axis and including a first distal portion and a second proximal portion, the second proximal portion of the connector engagement member including a threaded interior section engaging the threaded exterior section of the central core to attach the connector engagement member to the central core, the first distal portion of the connector engagement member including a front wall configured to contact an interface portion of an end-of-arm tool connector of a robotic arm.

18. The power operated rotary knife of claim 15 wherein the first distal interface portion of the central core of the handle assembly includes a threaded exterior section and the proximal interface portion of the frame body of the head assembly includes a threaded interior section, the threaded exterior section of the central core of the handle assembly engaging the threaded interior section of the proximal interface portion of the frame body of the head assembly to attach the handle assembly to the frame body.

19. The power operated rotary knife of claim 17 wherein the second proximal portion of the connector engagement member of the handle assembly includes a back wall and the first distal portion of the driver assembly retainer member of the handle assembly includes a front wall, the back wall of the connector engagement member contacting the front wall of the driver assembly retainer member.

20. The power operated rotary knife of claim 15 wherein the proximal interface portion of the frame body includes an annular boss, an outer surface of the annular boss including a radially extending shoulder disposed between an enlarged diameter forward section and a reduced diameter rearward section of the annular boss, the radially extending shoulder configured to contact an interface portion of an end-of-arm tool connector of a robotic arm.
